(19) United States
(12) Patent Application Publication
(10) Pub. No.: US 2003/0074298 A1
(43) Pub. Date: Apr. 17, 2003

(54) Information product market system and method

(76) Inventor: Wolfgang Daum, Schwerin (DE)

Correspondence Address: Stuart R. Hemphill, Dorsey & Whitney LLP, 220 South Sixth Street, Minneapolis, MN, 55402-1498, US

(21) Appl. No.: 09/901,488

(22) Filed: Jul. 9, 2001

(51) Int. Cl. G06F 17/60

(52) U.S. Cl. 705/37

(57) ABSTRACT

A method for operating a marketplace for sale of information products between information sellers and information buyers, involves connecting information sellers and buyers to communicate offers and communicate acceptance of offers for sale of information products and for a sales transaction entered into, facilitating at least one transaction payment between the information seller and buyer in such transaction. The method also involves, for a sales transaction at least partly performed, collecting evaluation data from the information seller and buyer on qualities of interest to future participants in the marketplace who may enter into information product transactions with such information seller and buyer, and processing the evaluation data under a weighting scheme to make the weighted evaluation data available to participating sellers and buyers.

### FIELD OF THE INVENTION

The present invention relates to a system and method for facilitating purchase and sale of information products.

### BACKGROUND OF THE INVENTION

There are many people in the world that have skills in very specialized fields. They are highly knowledgeable people of different kinds in different fields of knowledge. Some of these people are engineers working at large companies and hired to solve very specialized problems. There can be lawyers or medical doctors hired to solve special problems. They all desire to sell more of their knowledge. In some cases they will be employed but free to offer their knowledge to people other than just the employer where they are hired.

On the other side there are a lot of requests in the world for solutions to very specialized problems. There may be engineers who are working on a technical problem and suddenly need help in very specialized fields in which they are not skilled. There may be people who have questions about specialized law or medical problems and would like to obtain certain know-how within these fields of knowledge.

This invention proposes a method of bringing those knowledge requesters and knowledge providers together in a marketplace. This invention further proposes a method to evaluate both requesters and providers as participants in a knowledge marketplace.

There are different marketplaces in the world. The Internet offers a new, very interesting channel for selling and buying different things and services using an electronic data exchange.

There are Internet marketplaces for tangible goods, as at eBay.com. There are forums in the Internet where people exchange their knowledge and ideas and their opinions on different fields or subjects. However, the electronic data exchange format limitations of the Internet make it somewhat difficult for certain exchanges between buyers/receivers and sellers/providers to be made with confidence.

In most marketplaces today where the exchange does not take place by electronic data transfer the customer can examine the product, judge the product, and evaluate its price. For buying an apple at a fruit market, the smell and the look of the apple is important, so that the buyer can judge if he would like to pay the requested price. If the price seems to be too high for the buyer, based on his judgment of the quality, he will not buy the apple or demand a cheaper price. On the other hand, if the apple looks very good and smells delicious, the seller may be able to obtain a higher price than other apple sellers on the fruit market. The price at which the product will trade is determined by the quality of the product. But how can someone who requests knowledge or intellectual help via the Internet judge how good or bad the delivered answer or information product will be? There is a need for a method to facilitate the exchange of such information products and services by providing information that gives potential buyers and sellers what they need for marketplace decisions.

One way to develop such information is by looking at previous service results for a knowledge seller, that is to ask the past customers of the knowledge seller how good the information product was that the knowledge seller sold. This is what we call a recommendation on the seller. However, it is difficult for a knowledge buyer both to collect such recommendations and to evaluate them by comparison or otherwise. In situations where the seller needs information about the buyer, the information is similarly difficult to obtain.

There are a variety of Internet based marketplaces known today. However, knowledge or information product marketplaces are largely not found in the Internet, with the exception of databases that sell stored articles, texts or images. With these, the buyer can do little to customize the product received to its needs, because of interface or other limitations. One can find so-called forums that discuss diverse subjects. These forums are clubs of individuals, who have time to chat about different subjects. However, these forums have no direct marketplace function. One can also find a few sites at which medical or psychological consultations are available, but these provide little objective information about the quality of the information provided and may have a limited group of consultation providers. Other places to get knowledge are libraries. Libraries seldom carry the most current information, because this information often exists only in the heads of the specialists. Even Internet-based libraries have disadvantages, because they do not offer the user adequate ways to further develop or customize information and knowledge found. The libraries use the Internet primarily because it connects users to resources faster.

### SUMMARY OF THE INVENTION

The invention proposes a system to connect persons seeking information to persons providing information or knowledge in such a way that the ones providing the information get paid by the ones seeking information.

The invention proposes a way to connect information seeking and information providing parties, to facilitate their agreement on sale of an information product, and to facilitate the information product delivery and payment process.

The invention proposes a way to evaluate the quality of the information products provided by a statistical method.

The invention proposes a marketplace to buy and sell knowledge or information.

The invention proposes a marketplace for knowledge and information that uses the Internet, electronic mailing via telephone lines or any other means of electronic data transfer method or direct telephone voice or fax messaging.

The invention proposes a way for people to earn money by making greater use of their knowledge and skills.

The invention proposes a way for people to get quick, individualized and up-to-date knowledge or help.

For this invention it is useful to introduce some of the terminology used.

“Information product” means information, typically knowledge, advice or help, that is sold using the present system. Typically the information product will have no necessary tangible deliverables associated with it, and may be delivered electronically. However, some information products may include one or more tangible products that are closely linked to the intangible information. Information products will seldom be standard or off-the shelf items, but rather will require development or customization even where based on pre-existing components of information or knowledge. Information or knowledge is synonymously used to mean know how, the results of intellectual service, intellectual help, answers to questions, delivered reports, or the product of consultant work or advice. Examples of information products are: an engineer's solution to a design problem for an electronic circuit meeting certain functional specifications; an accountant/information technology specialist's plan for implementing a computer system that performs a certain business process; and an analysis and opinion from a legal or economic expert who is provided with background facts and one or more questions based on the background.

An “information product buyer” (or “a knowledge buyer” or “a buyer”) means a client, questioner, enquirer, person seeking advice, person seeking information, or knowledge receiver who uses the present invention to seek certain information or knowledge, i.e., and information product.

An “information product seller” (or “a knowledge seller” or “a seller”) means a consultant, researcher, advisor, person giving information, or knowledge provider using the present invention to provide information products.

A “participant” in the information product network or knowledge network is an information product buyer or an information product seller, i.e., a customer that uses the system. A participant may be an individual or a business entity made up of one or more individuals. (For simplicity, the description below will usually speak of a participant as an individual.)

The “system” means the information product network or knowledge network, help network, network agency, marketplace system or information product clearing house of the present invention.

A “score” or “mark” means a numerical or other rating or grading on a scale that is used to characterize performance of a participant or a quality of a deliverable on one or more dimensions of interest.

This invention is a method to present on the Internet or other communication network a proposal from a potential buyer for an information product purchase and to receive from potential sellers one or more proposals for an information product sale corresponding to the potential buyer's proposal for an information product purchase. The potential buyer's proposal is communicated to potential sellers with a buyer profile file. The potential seller's proposal is communicated to the potential buyer with a seller profile file. The potential seller profile file will contain one or more grades or marks, e.g., a certain score (for instance from 1 (not good) to 10 (excellent)) on one or more scales or dimension of evaluation. Any number in between these limits will then communicate a certain score between “not good” and “excellent” to tell the potential buyer about the potential seller. The scores are given by previous buyers that have done business with the potential seller and have judged how good the information product provided was and how the potential seller performed on other evaluation factors, such as how promptly the information product was provided. The statistical base for the scores may be presented. The more business the potential seller has done, the better the statistical base will be for the scores. The potential buyer may also see how the scores of a seller have developed in the past. The scores may be weighted by the price a seller has obtained, by the speed of performance, or by any other factors of interest to a potential buyer. The buyer may then look at the different proposals from potential sellers and may judge the different prices based on the associated seller profile file and the known scoring system.

The potential buyer may also have certain grades or marks on one or more scales in the potential buyer profile associated with the buyer's proposal. Each scale is a factor or dimension of interest to a potential seller. For example, a potential buyer might be scored based on its ability to provide a well-prepared statement of what is required in the desired information product, that is, whether the buyer's requested information products have been well-defined from a seller viewpoint. Depending on how well prepared the potential buyer was in prior dealings with seller, the potential buyer could have a score from 1, which could stand for “not prepared at all” to 10 which could mean “excellent definition, well prepared”. With this score the potential buyer might show that he is not experienced in a field or is a very experienced buyer of information products in a field. Therefore, the potential seller will know if he deals with somebody who is very well-prepared and focused in defining an information product (or not so prepared). From a well-prepared potential buyer, a seller should get clearly defined proposals, tasks or questions and therefore can expect to deliver his service more efficiently.

In one embodiment, the potential buyer profile file will be shown to a potential seller, and the potential seller profile file will be shown to the potential buyer without other identification of either buyer or seller. Also the number of information products for which each has acted as seller or buyer will be shown to the other.

### DESCRIPTION OF THE DRAWINGS

The detailed description of the invention will make clear the new method and system. The description uses flow-charts, diagrams and graphs, which are shown in the drawings.

FIG. 1 shows a flow chart of the overall program description. The numbers in the flow chart refer to sub-flow charts as described below.

FIG. 2 shows the part of the program that accepts and enrolls a knowledge seller.

FIG. 3 shows the part of the program that accepts and enrolls a knowledge buyer.

FIG. 4 shows the part of the program that takes in a knowledge buyer inquiry.

FIG. 5 shows the part of the program takes in a knowledge seller offer.

FIG. 6 shows the part of the program where the seller and the buyer negotiate and establish a price.

FIG. 7 shows the part of the program in which the seller is performing the information product services in response to the buyer's order.

FIG. 8 shows the part of the program where the buyer has a complaint.

FIG. 9 shows the part of the program in which financials are to be cleared.

FIG. 10 shows the part of the program in which the buyer will evaluate the delivery and the seller.

FIG. 11 shows the part of the program in which the seller evaluates the buyer and his order or enquiry.

FIG. 12 shows the part of the program in which the knowledge seller is offering new knowledge.

FIG. 13 shows exemplary information about the seller given to the buyer.

FIG. 14 shows some statistical evaluation of the seller.

FIG. 15 shows a price finding graph.

FIG. 16 Mark development 1

a Constant trend, equally distributed variation

b Constant trend, normally distributed variation

FIG. 17 Mark development 2

a Linear-cyclic trend, equally distributed variation

b Linear-cyclic trend, normally distributed variation

FIG. 18 Order marks-rank marks, no decay, unitary weightings

a Constant trend, equally distributed variation

b Constant trend, normally distributed variation

FIG. 19 Order marks-rank marks, no decay, unitary weightings

a Linear-cyclic trend, equally distributed variation

b Linear-cyclic trend, normally distributed variation

FIG. 20 Order marks-rank marks, linear annual decay, various weightings

a Constant trend, equally distributed variation

b Constant trend, normally distributed variation

FIG. 21 Order marks-rank marks, linear annual decay, various weightings

a Linear-cyclic trend, equally distributed variation

b Linear-cyclic trend, normally distributed variation

FIG. 22 Order marks-rank marks, exponential annual decay, various weightings

a Constant trend, equally distributed variation

b Constant trend, normally distributed variation

FIG. 23 Order marks-rank marks, exponential annual decay, various weightings

a Linear-cyclic trend, equally distributed variation

b Linear-cyclic trend, normally distributed variation

FIG. 24 Order marks-rank marks, trigonometric annual decay, various weightings

a Constant trend, equally distributed variation

b Constant trend, normally distributed variation

FIG. 25 Order marks-rank marks, trigonometric annual decay, various weightings

a Linear-cyclic trend, equally distributed variation

b Linear-cyclic trend, normally distributed variation

FIG. 26 Order marks-rank marks, root-extension decay, various weightings

a Constant trend, equally distributed variation

b Constant trend, normally distributed variation

FIG. 27 Order marks-rank marks, root-extension decay, various weightings

a Linear-cyclic trend, equally distributed variation

b Linear-cyclic trend, normally distributed variation

FIG. 28 Order marks-rank marks, arc-tangent extension decay, various weightings

a Constant trend, equally distributed variation

b Constant trend, normally distributed variation

FIG. 29 Order marks-rank marks, arc-tangent extension decay, various weightings

a Linear-cyclic trend, equally distributed variation

b Linear-cyclic trend, normally distributed variation

FIG. 30 High-level block diagram of the components of an information product marketplace system.

FIG. 31 High-level block diagram of operation of an information product marketplace system.

### DETAILED DESCRIPTION OF THE INVENTION

A. System Overview

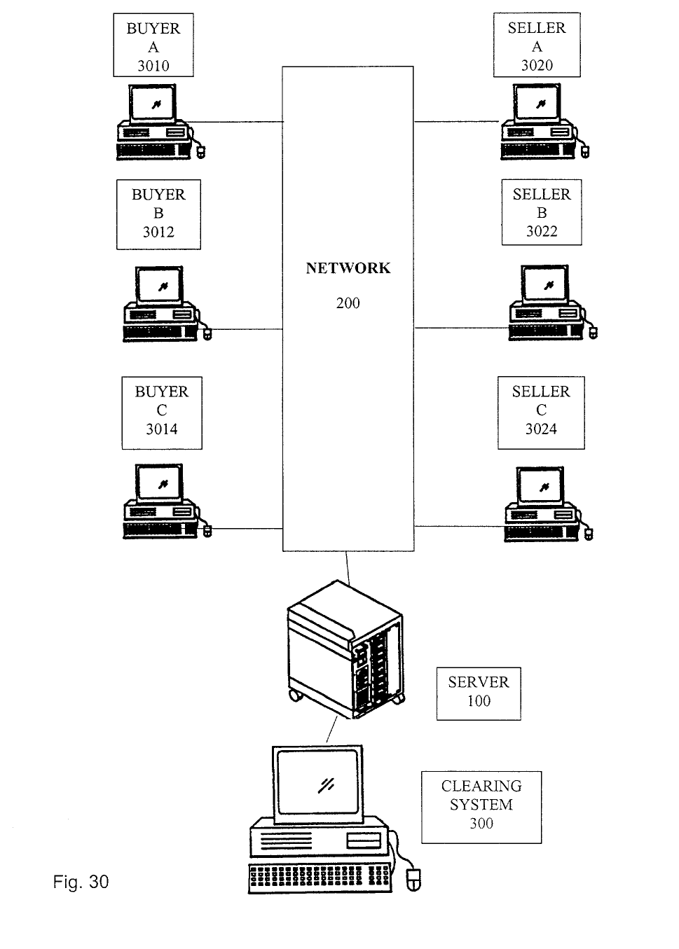

FIG. 30 shows a high-level view of the information product marketplace system. Potential Buyers A, B and C 3010, 3012, 3014 and potential Sellers A, B and C 3020, 3022, 3024 are represented by computer terminals (PC's, PDA's telephones or any other device for sending and receiving data) and are all connected to the Internet or some other public or private communications network 200. A server 100 on which the marketplace system may be implemented is also connected to the network 200. The server 100 includes not only one or more processors but also storage devices for both the software (operating systems, applications, database manager) for the functions of the system and the databases in which information used in the system is stored. The server 100 may be connected to a clearing system 300 by which financial operations for transactions handled by the server 100 are cleared. The clearing system 300 may be a system operated by the operator of the information product marketplace system or by a separate provider of financial services, such as a bank or a credit card payment processor. The server and its various network connections to participants and to the clearing system 300 may be monitored and operated by a system operator (not shown) who puts the system in place and operation.

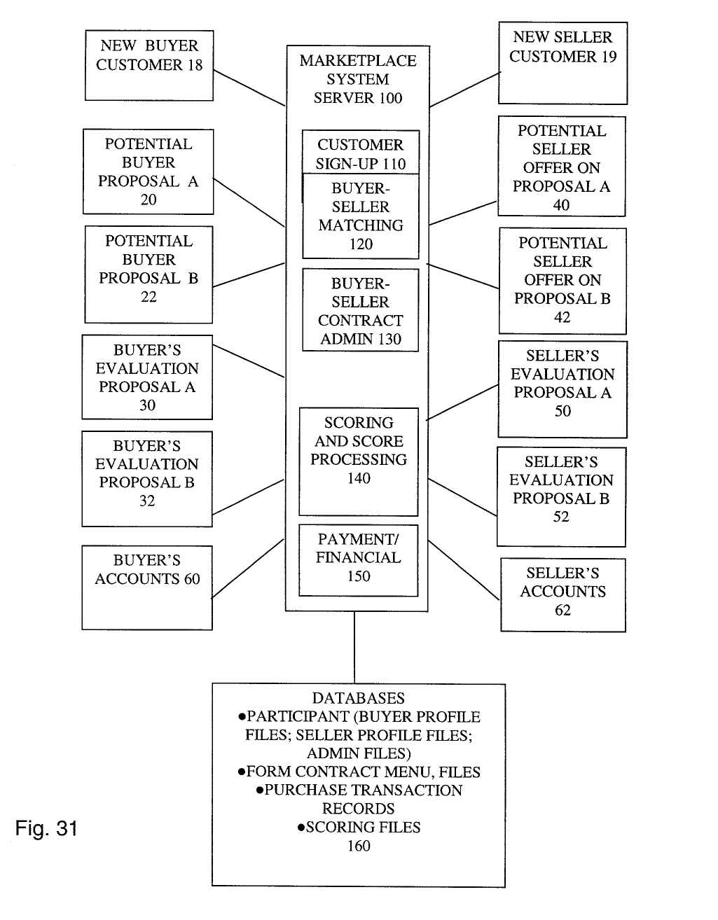

FIG. 31 shows a high-level view of elements involved in the operation of the information product marketplace system. The marketplace system server 100 has within it a variety of functional modules or components implemented in software or hardware/software subsystems including: customer sign-up 110, buyer-seller matching 120, buyer-seller contract administration 130, scoring and score processing 140 and payment/financial 150. The marketplace server system has access to databases 160, which may include customer files (customer/participant contract and administration files, buyer profile files, seller profile files), form contract menu and files, information product purchase transaction files and scoring files, as well as any other databases needed for the server 100. The server 100 receives communications from a variety of sources with which it may communicate over the network 200 as shown in FIG. 30 or over any other internet, intranet or communication network, wired or wireless.

The server 100 may process new customers, such as new buyer customer 18 and new seller customer 19, using customer sign-up module 110. The server 100 may also receive proposals from potential buyers for information product purchase transactions, for example, Potential Buyer Proposal A 20 and Potential Buyer Proposal B 22. The server 100 may also receive proposals from potential sellers of information products corresponding to proposals from potential buyers for information product purchase transactions, for example Potential Seller Offer on Proposal A 40 and Potential Seller Offer on Proposal B 42. A potential buyer and a potential seller are brought together by operations of the buyer-seller matching module 120, which may communicate potential buyer proposals for an information product purchase to potential sellers, together with a buyer profile file. The buyer-seller matching module 120 may communicate responsive potential seller proposals corresponding to a potential buyer proposal for an information product purchase to potential buyers, together with a seller's profile file. While a buyer-seller matching module or component could simply categorize all seller proposals and buyer proposals, show which proposals are responsive to other proposals, and provide customer navigation tools to access proposals, it could also be configured to be more pro-active. For example, the buyer-seller matching module may show any subject matter connections between pending proposals and orders and past proposals and orders that are part of a buyer or seller profile. The identification of comparables and evaluation of comparability may assist buyers and sellers in determining a suitable match between these.

The process of a buyer and a seller reaching an agreement is facilitated by the buyer seller contract module 130. It can provide a message and presentation format that assists the parties in communicating their respective negotiating positions if there initially is no acceptable offer for one of them simply to accept. The seller contract administration module 130 may offer standard contractual terms in one or more varieties to the parties. These may differ somewhat in risk allocation terms (warranties of conformity or respecting defects in deliverables, indemnifications for third party claims of infringement or other damage, and similar legal provisions), or in payment or other terms, but are otherwise relatively balanced and intended to help the parties reach a meeting of the minds, so that an “order” both participants have accepted can proceed through the system. The participants' contract may be subject to electronic signatures managed by the system and to archiving in the system. This provides the participants with an independent archiving source for the documents that govern their transaction, which may be useful should a dispute arise.

If the buyer and seller desire, they can communicate with the assistance of the buyer-seller contract administration module 130 for the duration of the performance of their agreement. Thus, this module may during contract formation propose a milestone structure for performance of the parties' agreement and (if accepted) help them to follow the progress of performance against the agreed milestones. In one embodiment, the marketplace system operator may provide audit services in which it reviews deliverables or other data regarding performace and aids the parties in determining whether a performance milestone has been met. This determination may further link to a payment made through the system or to a dispute resolution procedure.

Once active performance of a purchase contract is done (which usually means satisfactory completion, but could also mean failure to reach planned completion by mutual early termination or by reason of an unresolved dispute between buyer and seller) the server 100 seeks and collects buyer's evaluations 30, 32 and seller's evaluations 50, 52 from each of the buyer and seller. For example, if each of the Buyer Proposals A and B led to purchase contracts and the performance under these was done, the server 100 seeks evaluations from each buyer and seller involved in Buyer Proposals A and B. Preferably, to insure completion of these evaluations, the operator of server 100 may have a contractual requirement for completion of this evaluation information and, in addition, financial or other arrangements that incent buyers and sellers to complete promptly and accurately evaluation forms provided by the system operator. Thus, the scoring and score processing module 140 may receive Buyer's Evaluation-Proposal A and B 30, 32 and Seller's Evaluation-Proposal A and B 50, 52.

All of the evaluation data become available to include in a seller profile file and a buyer profile file. Preferably, the evaluation data is processed under various statistical procedures to make it more valuable and intelligible to participants. However, certain transaction evaluation data, such as a description by buyer and/or seller of the subject matter involved or the nature of the information product order may best be presented to participants unprocessed, to provide a direct example of previous jobs undertaken. Such descriptive information may be accompanied by the price associated with the previous jobs.

To provide additional potentially useful information to system participants, the system operator may also provide participants to a transaction an incentive to disclose all or most of their communications and negotiations to later participants. For example, the system might reduce its fees for such additional disclosure and share the fee reduction between the buyer and seller.

Payment is facilitated by use of the payment/financial module 150 when an information product transaction reaches an intermediate or final payment stage under the contract made by the participants. If electronic funds transfer is desired, the payment/financial module 150 may be in communication with buyer's account 60 and seller's account 62 and any necessary clearing service.

We next turn to a more detailed description of functions within the information product marketplace system.

B. Method Overview

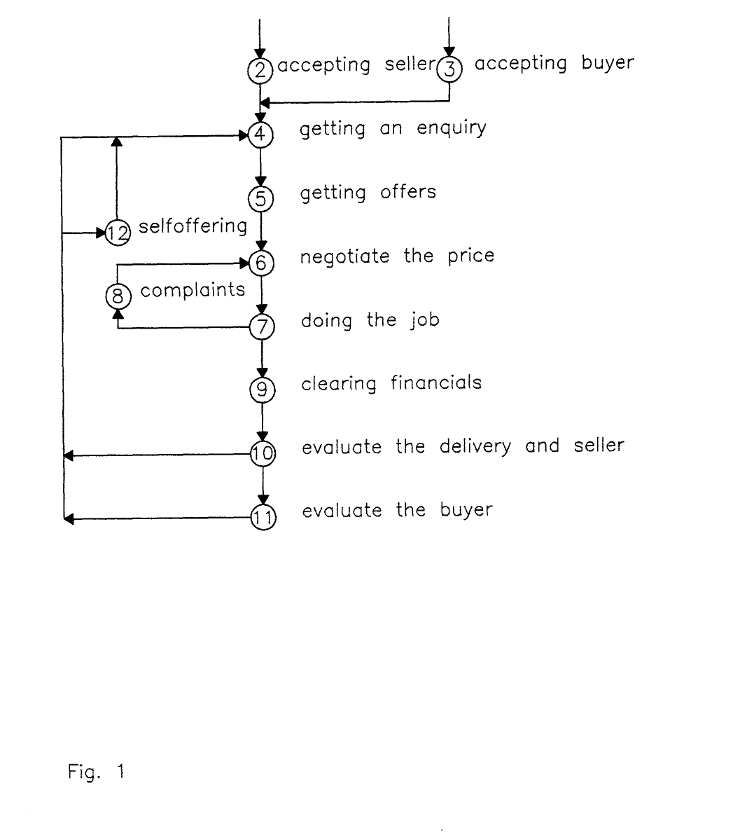

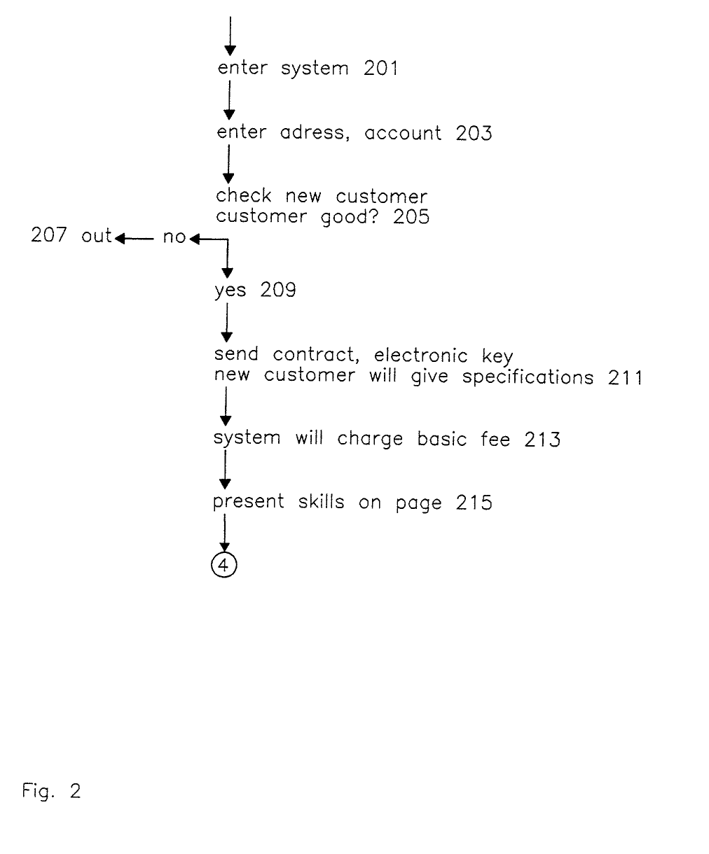

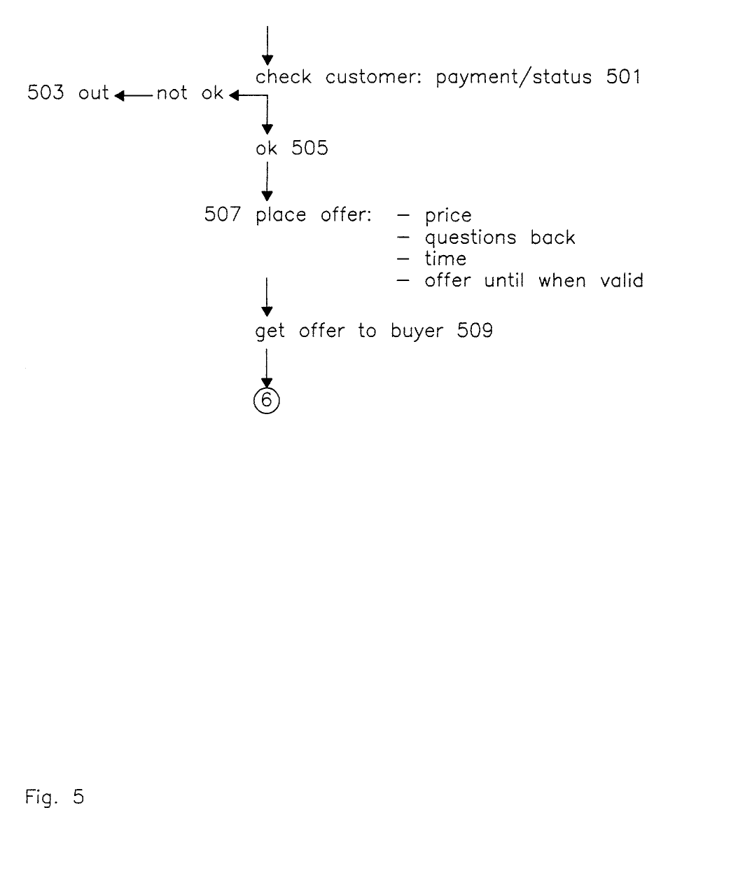

The circled numbers in FIG. 1 indicate sub-processes represented in FIGS. 2-12; e.g., the sub-process of accepting a seller is detailed in FIG. 2, and the process of taking in an offer is shown in FIG. 5. FIGS. 2-12 also have circled numbers showing linkages between sub-processes.

FIG. 1 shows the overall method implemented in the system. The knowledge seller enters the invented system for acceptance and enrollment (2). The knowledge buyer also will enter this system for acceptance and enrollment (3). The knowledge buyer sends an enquiry that is received at the system (4); that is, he has a certain question to be answered or consulting task to be performed and wants to propose a purchase of know-how or knowledge or an information product. The knowledge sellers present and the system receives offers in response (5). The knowledge buyer and the knowledge seller negotiate a price (6) and any other terms, and finalize their agreement. The knowledge seller will do the job and deliver the information product (7). The knowledge buyer may have complaints (8), which may lead to further work or to renegotiation of the price, delivery time or other terms. After completion, financials will be cleared (9). The knowledge buyer will evaluate the delivery (information product) of the knowledge seller (10) and other qualities of the seller. The knowledge seller will evaluate the enquiry (proposal for purchase of an information product) or other qualities of the knowledge buyer (11). There might be knowledge offerings of the knowledge seller on its own initiative (“self-offering”) (12) that could initiate an information product purchase enquiry or proposal when viewed by a buyer.

In another embodiment the buyer and seller would not negotiate the price but rather let the system develop a price based on prior transactions and on the seller profile file, the buyer profile file and current buyer and seller proposals. This system-calculated price may then be offered to the participants as a guideline or as a mandatory price set by the system. Any mandatory pricing would have to be by prior agreement.

C. Enrollment of Buyers and Sellers (Customer/Participant Sign-up 110)

FIG. 2 shows the procedure, when a new information product seller enters the system for enrollment 201. After the proposed information seller has entered the system, he will provide his name, address and his financial account information 203. The system will then check the new seller to determine if he is acceptable or not—for example, if the system has had any problems with this seller in previous times, or if other business rating criteria are met 205. If the seller is not acceptable, he will get a message that he is rejected and the system will not consider him further 207. If the new seller is acceptable 209 and there are no reasonable complaints against the new seller, the system will send him a written (hard copy or e-copy) participation contract and, upon contract acceptance, give him an electronic key to enter the system in future, such as a PIN number (personal identification number which only the seller knows) 211. (The invention is not limited to electronic keys known today, such as PIN numbers. In future there might be other and safer authorization methods for such systems.) The system may charge an initial or basic fee to the new participant 213. The new information product seller participant may now present certain skills, e.g., by a presentation made available on a page or site within, or linked to by, the system 215.

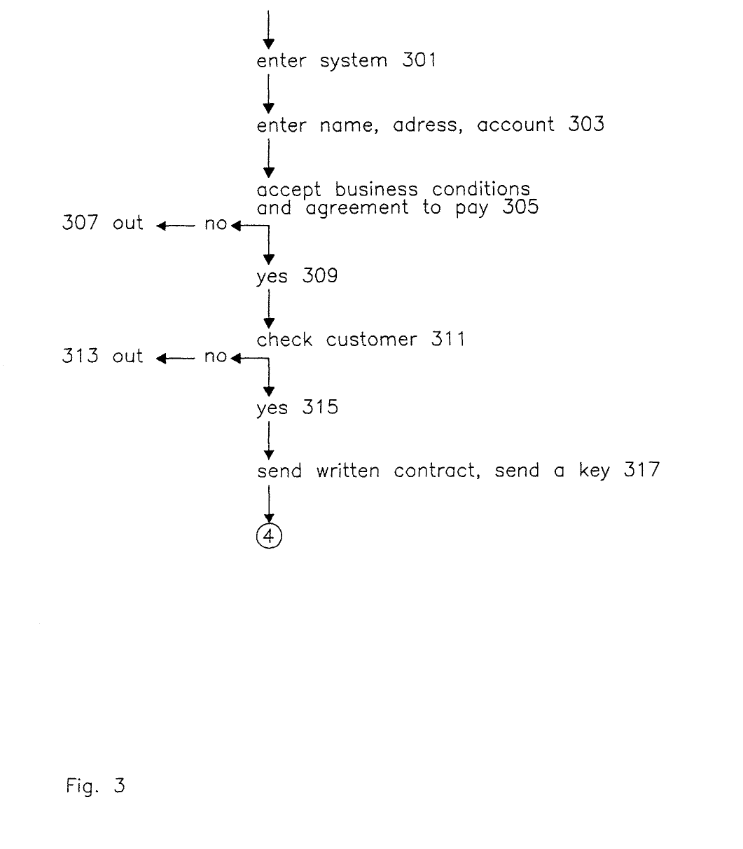

FIG. 3 shows the procedure when a new information product buyer wants to enter the system for enrollment. The new information product buyer will enter the system 301, give his name, address and account information 303. He will receive a written (hard copy or e-copy) participation contract, addressing payment of the fees and other business conditions and to proceed must accept these 305. If the buyer does not complete enrollment and accept the participation contract, he will be rejected and the system will not consider him further as a participant 307; otherwise, the buyer proceeds 309. The system may check the buyer's record (if any) on payment of previous bills and invoices or other business rating criteria 311. If the credit risk is too great, again he will be rejected and the system will not consider him further as a participant 313. If he is viewed as a good participant 315 the system will send him any necessary further contracts or documents and a key to enter the system as participant 317. This key might be the PIN (personal identification number) as mentioned above or any other electronic key.

The system may be designed to accept participants' electronic signatures or wait to finalize participant acceptance until a written and signed contract has been returned.

D. Buyer Proposals and Seller Proposals in Response (Buyer-Seller Matching 120)

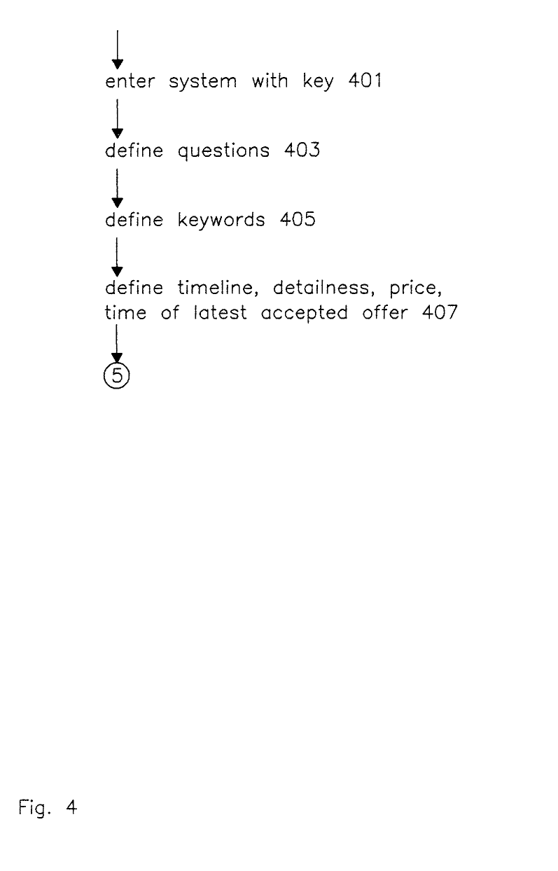

FIG. 4 shows the procedure when a proposal of an information product buyer is entered into the system. The information product buyer will enter the system with his name and his electronic key (such as a PIN) 401. The buyer will define his proposed information product by means of one or more questions 403 (including any necessary background), and he may define certain key words or terms for specifying the desired information product 405. He will define a time line for one or more deliverables and the specifics or details required in response to his questions 407. He may also name a price he would be willing to pay and the latest date at which he will accept a proposal from an information product seller, i.e., a seller's offer in response to the buyer's proposal. If the buyer's proposal involves confidential information, the system may receive the buyer's proposal in such a way that it will be presented only to potential sellers that sign a confidentiality agreement. The system can facilitate this with an appropriate agreement form presented to potential sellers for on-line or hard copy signature. The system may permit the parties to select such agreement parameters as governing law, form of dispute resolution and place for resolution (e.g., court or arbitration body).

FIG. 5 shows the procedure of handling a proposal from an information product buyer. The system will check the buyer's previous payment history and the current status of the buyer 501. If the system finds the buyer is not a participant in good standing, it will reject the buyer and the proposal will not be considered further 503. If the buyer is in good standing 505, the system will make the buyer proposal available via the network 200 to information product sellers, who can view the proposal. The buyer proposal may be accompanied by the buyer profile file. The system may try to match the buyer proposal with the skills defined as keywords of the information product sellers, so that the attention of relevant sellers can be drawn to a buyer proposal that may suit them. The information product seller may now define his price, and seek any necessary clarification of the buyer's proposal through questions back to the buyer 507. The seller thus may make an offer in response to the buyer proposal, which will specify the time by which he expects to be able to deliver the information product deliverables and also the time within which his offer is valid. The system then will get the seller's offer to the information product buyer 509. If the seller's proposal involves confidential information, the system may receive the seller's proposal in such a way that it will be presented only to potential buyers that sign a confidentiality agreement. The system can facilitate this with an appropriate agreement form (which may be a mutual confidentiality agreement) presented to potential buyers for on-line or hard copy signature.

E. Buyer-Seller Contract Administration

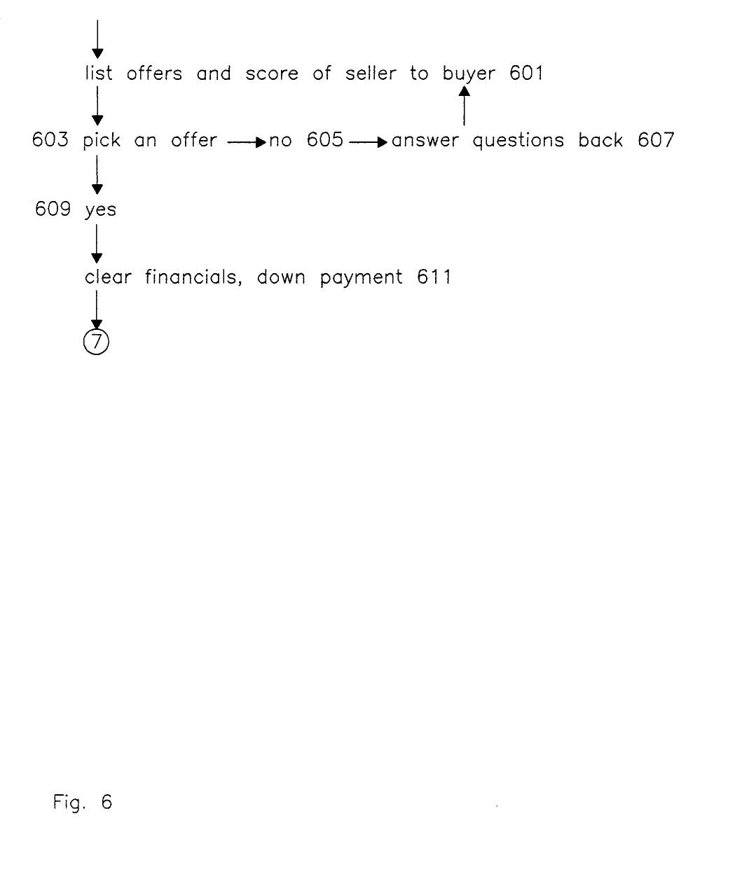

FIG. 6 shows the procedure to negotiate and establish the price. The information product buyer may now see a list with offers or proposals with associated questions in response to his proposal for an information product purchase 601. With each offer or proposal he may see the information product seller's profile file, i.e., the seller's scores under the evaluation method for sellers. In one embodiment, the seller's profile file will not include any name identifier and the buyer will not know who the seller is, except for the score or grading information in the seller's profile file. In one embodiment, the seller sees only the buyer's profile file and does not know the specific identity of the seller. Such anonymity may help ensure that participants rely on the objective data supplied by the system for their decisions about a buyer or seller. It may also assist sellers that are employed to provide services to which an employer might object. (It will be up to the employee and employer to deal with the scope of any non-compete or other employment contract limitations.)

The buyer can now pick any offer 603 in response to his proposal that is complete and accept it 609. The terms of the contract governing the information product purchase are preferably selected from standard terms provided by the system operator from database 160. (However, the participants also may define their agreed terms outside the system and simply inform the system that they have reached agreement.) There is an exchange of signatures (which may be electronic) and the system may file a copy of the parties' agreement as documentation for this transaction.

If the knowledge buyer does not find any acceptable seller offer that is complete, or if a completed offer might be made acceptable with adjustments to price or other terms 605, the buyer can send questions back or other communications 607 intended to lead to a meeting of the minds. That is, the buyer can provide answers to questions raised by a seller who needs more information to complete its proposal. The buyer can also identify an offer of interest that would be acceptable with certain changes and communicate with the seller to discuss changing a certain term or condition that is not acceptable or to propose an adjustment to a lower price, acceptable to the buyer. The buyer's counter-offer then will be either accepted or not accepted. If the information product seller does not accept the buyer's counter-offer, he can go back to the buyer with a new proposal attempting to accommodate the buyer. This might go on for several rounds (looping through steps 601, 603, 605, 607), with both parties still not knowing who the other is. Only by the scores, price and other information that have been given in the respective buyer profile file and seller profile file do they have an understanding of each other.

Obviously, someone with a better seller profile file can generally ask for more money for his knowledge and information products while someone with a lesser seller profile file might offer a lower price. Similarly, a buyer with a better buyer profile file can generally negotiate for better pricing than someone with a buyer profile file that is less attractive to a seller.

An accepted contract may call for the buyer to pay a certain down payment. If so, the system acts as a clearing house for financials 611. It collects the money from the buyer's account 60 and will transfer it to the seller's account 62 (see FIG. 31). The system may charge a percentage or other fee to cover its own costs and profit objectives.

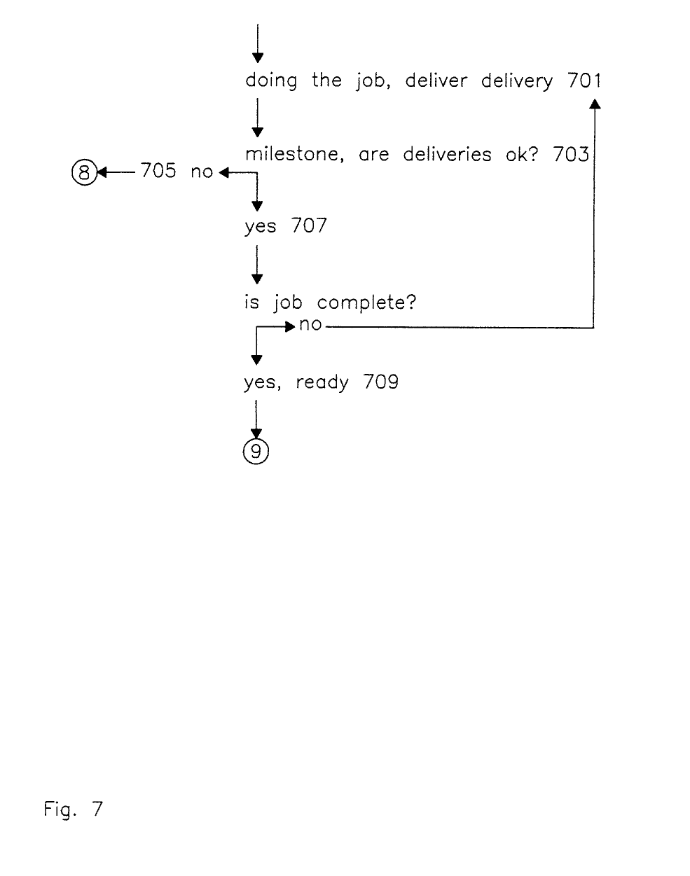

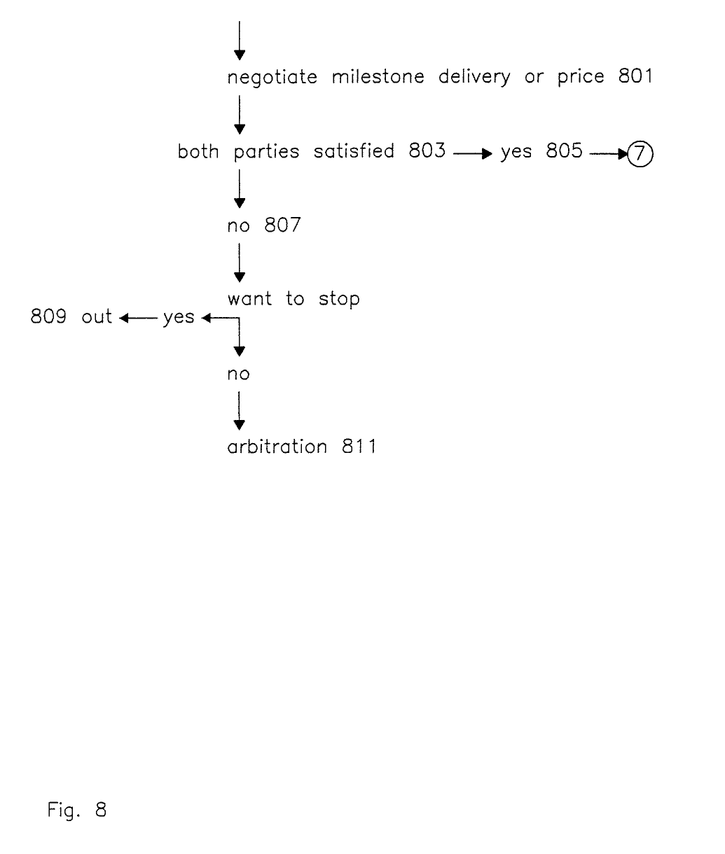

FIG. 7 shows the process of doing the job that produces the contracted-for information product. The seller will do the job and should deliver the contractually agreed deliverables at certain milestones 701. At each milestone, the deliverables are checked for conformance with agreed specifications 703. The system may provide audit services for deliverables to assist the buyer and seller. Alternatively, the parties may simply inform the system of their agreement that one or more deliverables have been accepted. If the milestones are not achieved or there is a dispute about whether deliverables conform to the contract 705, there can be further negotiations about the complaint, such as how much is still to be paid or about additional work and redelivery 701 to make a deliverable conform (see FIG. 8). If the milestones are reached 707 and the seller has satisfactorily completed all his milestones, the buyer should be ready to make the agreed payment(s) 709.

FIG. 8 shows the procedure of dealing with complaints or buyer/seller disagreements. If a deliverable for a milestone is late or does not conform to the contract (according to the buyer), seller and buyer can renegotiate the timing or the specifications associated with the milestone, and/or adjust price 801. The parties consider whether there is now a satisfactory outcome 803. If so 805, the process of doing the job continues (see FIG. 7). If both parties do not agree on a solution for the dispute 807, there might be the possibility to stop the whole process 809 or to go to an arbitration 811. This arbitration might be offered by the system or by others. There might even be a seller found in the system to offer the service of doing arbitration and delivering its judgment as an information product. There might be sellers and buyers who act together to offer their arbitration service on a regular procedure to other participants who have unresolved disputes.

F. Payment/Financial

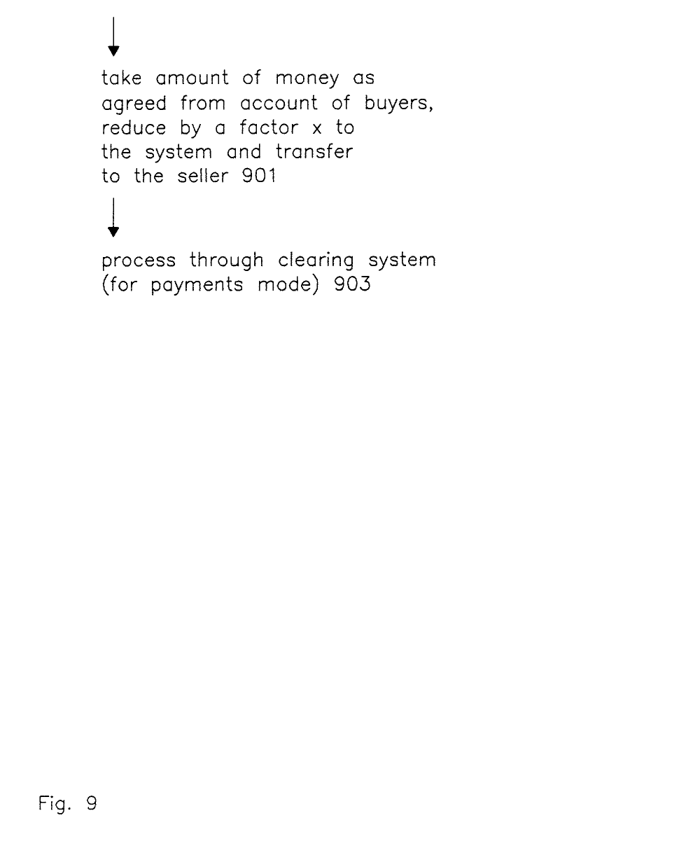

FIG. 9 shows the procedure used to clear the financials for a given information product transaction. The system will charge the buyer's account 60, which might be accessed via credit card, and will arrange to transfer a contractually agreed amount to the seller 901 (by use of the seller's account 62). The system will reduce the amount charged to the buyer by a factor X (such as 5% or other agreed amount), for the service the system has offered. (The system will have to fund itself largely on this money.) The payments can be handled through any suitable clearing system 903. There are many financial systems that permit such transfers of funds to be made; thus we will not detail this procedure further. Any taxes applicable to these payments may be taken care of here.

G. Scoring and Score Processing

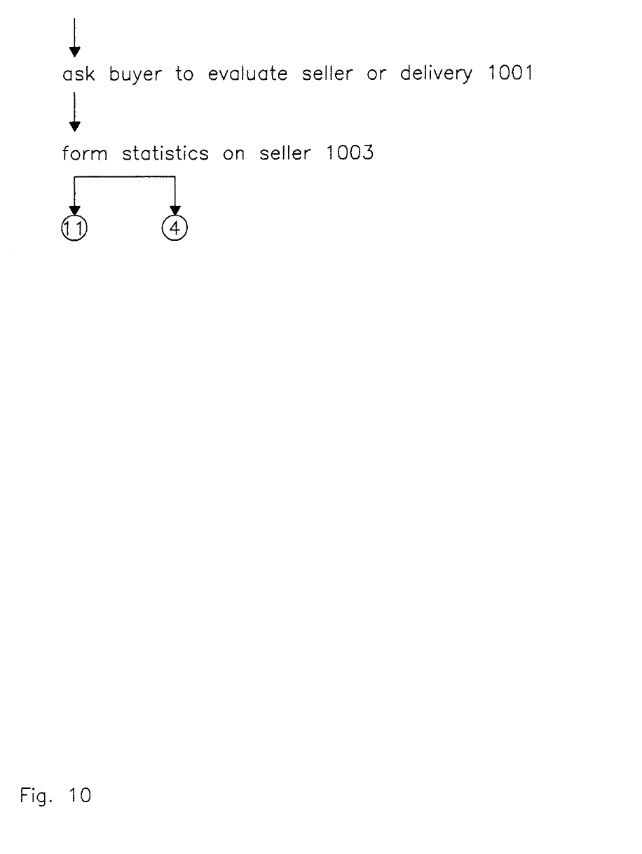

FIG. 10 shows the evaluation process for the deliverables and/or the seller as participant in a transaction or information product order. There might be scores or marks between 1 for “not good” or “bad” to 10 for “excellent.” (The initial score may designate no experience with the seller and no score, as yet.) An example is given in the following table:

| | |
|---|---|
| 0 | has never answered questions yet |
| 1 | not to recommend at all, system will delete seller soon |
| 2 | very bad |
| 3 | bad |
| 4 | below average |
| 5 | average |
| 6 | above average |
| 7 | fairly good |
| 8 | good |
| 9 | very good |
| 10 | excellent |

There might be more scores on other scales or evaluation dimensions for time of delivery, for fairness if complaints occur or for cooperation at delivery, such as whether the seller could explain his answers to the buyer's questions about a deliverable articulately and usefully.

The buyer is asked to evaluate the seller and the seller's deliverables, preferably by a computer-presented form (from scoring and score processing component 140, see FIG. 31) that guides and standardizes the evaluation 1001. Once the information (evaluation data) is collected, the scoring and score processing component 140 can begin the process of: calculating scores; preparing tables, graphs or other ways of presenting information so that it is readily understood; and doing any necessary updating of the statistical history that may be a part of the seller profile form 1003.

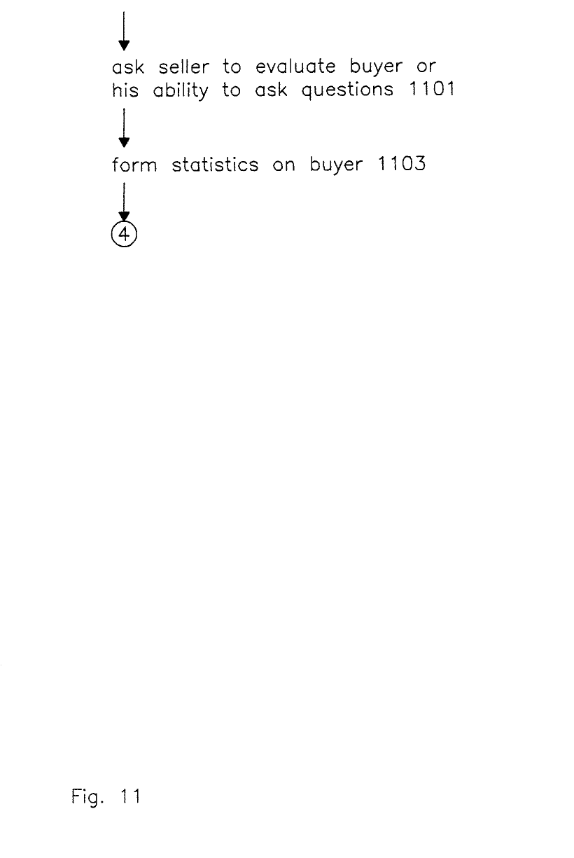

FIG. 11 shows the evaluation process by the seller for the enquiry or proposal from the buyer and for the buyer as participant in a transaction. There might be scores or marks between 1 for “not good” or “bad” to 10 for “excellence” in asking the question. (The initial score may designate no experience with the buyer and no score, as yet.) An example is given in the following table:

| | |
|---|---|
| 0 | has never had an enquiry yet |
| 1 | not to recommend at all, system will delete buyer soon |
| 2 | very bad |
| 3 | bad |
| 4 | below average |
| 5 | average |
| 6 | above average |
| 7 | fairly good |
| 8 | good |
| 9 | very good |
| 10 | excellent |

There will be scores on one or more scales for the information product enquiry and interaction with respect to deliverables. There might also be more scores for time lines in answering seller questions, for fairness if complaints occur, or cooperation at delivery, such as whether the buyer could explain his enquiry or articulate well the requirements for the information product and any claimed deficiencies of a deliverable relative to the requirements.

The seller is asked to evaluate the buyer and the buyer's proposal for purchase of an information product 1101. This is done preferably by a computer-presented form (from scoring and score processing component 140, see FIG. 31) that guides and standardizes the evaluation 1001. Once the information is collected, the scoring and score processing component 140 can begin the process of: calculating scores; preparing tables, graphs or other ways of presenting information so that it is readily understood; and doing any necessary updating of the statistical history that is a part of the buyer profile form 1103.

The system may start a buyer or seller profile with an arbitrary average score on one or more scales or dimensions. The system may for the example range here between 0 and 10, select an arbitrary average score of 4 or 5. After a certain time when a participant has been involved in several information product transactions, the system will then give him back in statistics different, statistically-based scores. In this process there might be milestones defined which are to be done in order to subdivide the whole procedure.

It should be clear that the system uses statistics to evaluate the score of a seller or a buyer. The system might decide not to score the buyer at all; however, it is believed that the marketplace system will be improved by accumulating information on both sellers and buyers. The more information product jobs a seller has done, the better the system can provide a sound evaluation of the seller. There may be multiple sets of scores or ratings for a seller. One seller might have knowledge in different fields of subjects. Therefore the system may give him a score or set of scores for each field or sub-field of subject.

The scores can be weighted by the price of the job or information product. If a seller had 30 jobs for the price range of less than 1000 dollars and one job for more than 10,000 dollars, this larger job might be given a special treatment in the seller's score. A higher-priced job score might be weighted more than the score on a lower-priced job, in proportion to the ratio of the higher and lower prices. The evaluation scores might also be weighted based on the time the seller had to answer a complicated question. Another way of weighting the seller's score is to consider the speed of the answer or the score of the buyer in the same transaction, both of which might have an effect on the seller's performance.

Similar weighting methods for the scores evaluating the buyer and the buyer's performance can be developed.

H. Seller Presentation

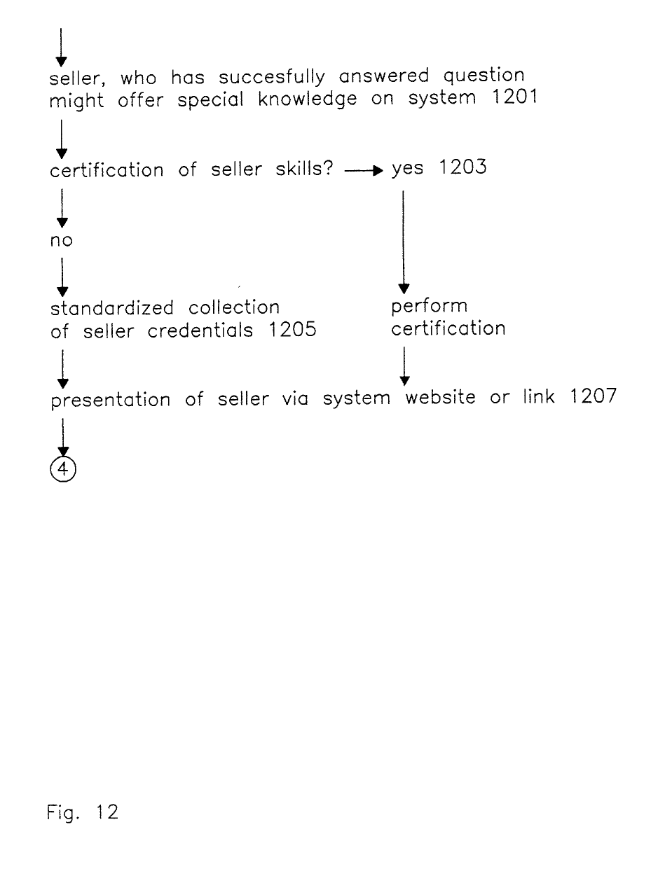

FIG. 12 shows that a seller, who has exceptional knowledge, can offer skills in certain subject areas by offering his service by a presentation on the system's web-page or a site linked to from the web-page 1201. There may be procedures to evaluate if he has exceptional knowledge and thereby have the system provide certification of the skill level 1203. The system might decide to accept the seller without any test, but with some standardized way of collecting and presenting the facts that comprise the seller's claimed credentials 1205. These could be certified to by the seller and could be subject to review and modification as needed by the system as experience and data are acquired in the seller's profile file. The system can provide the seller presentation via the system website or a link 1207.

I. Scoring and Score Processing

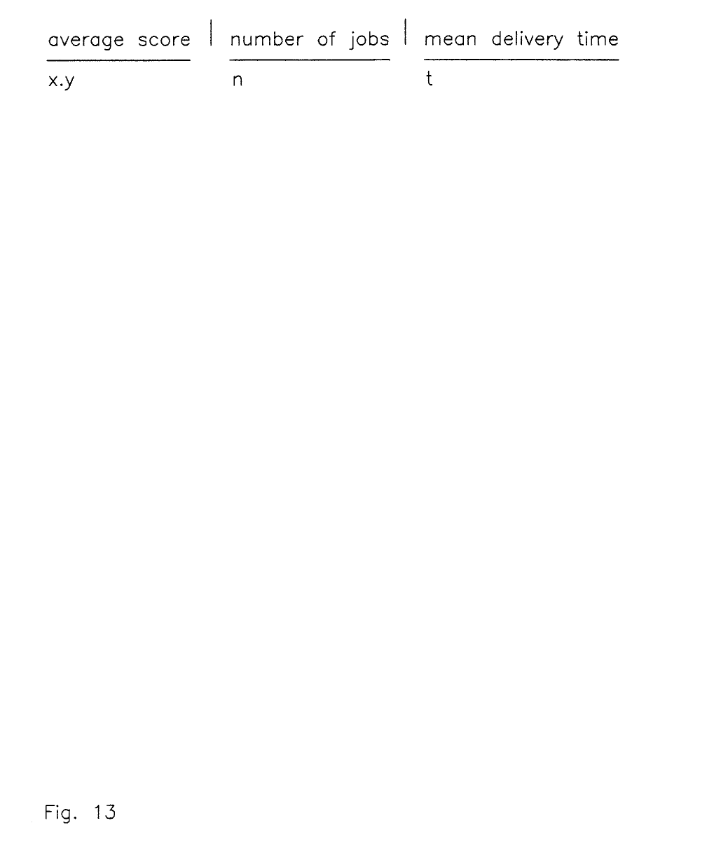

There may be several different ways to present the scores of the seller that are part of the seller profile file. FIG. 13 shows the score presentation by simply calculating the numbers “average score” (on some summary scale or primary dimension), “number of jobs” and “mean delivery time” from evaluations and presenting them in a table on the system's web page or as part of a seller profile file. A similar simplified tabular form can be used for the scores associated with buyers (with “mean delivery time” replaced by a measure of timeliness more relevant to buyers, such as a response time for questions raised by potential sellers examining a pending inquiry). To the extent seller and buyer scores are part of a profile file that is associated with the presentation of a proposal by a buyer or seller, the buyer or seller profile file may be updated during the time a potential buyer's information product proposal is pending or a potential seller's corresponding response to a proposal is pending. Thus, each of buyer and seller can be notified of an update in a profile while a proposal is pending and can review the proposal with the latest evaluation information available.

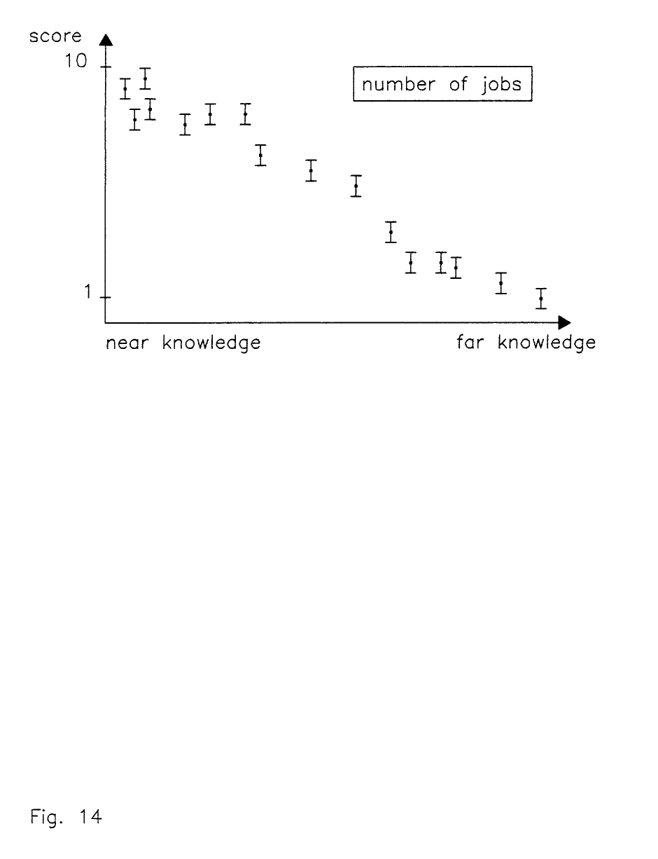

Many statistical measures become more understandable if presented graphically. FIG. 14 shows a way to present a seller's score or marks on some scale or dimension in a graphic way. Shown on the x-axis is how close the information product enquiry was to the core knowledge of the seller. If the enquiry was far away from the core knowledge, the score is shown on the right hand side. The further left the graph shows the enquiry, the closer it was to the core knowledge of the seller. It is obvious that the seller and the system first had to define the “closeness” of the enquiry to his core knowledge by an appropriate measure. Thus, core knowledge and distance from core knowledge are concepts to be determined elsewhere within the context of the system. For example, the system might prepare a matrix of knowledge classifications, based on keywords used in matching sellers and buyers, with appropriate ranges and measures showing relatedness of certain subject matter fields.

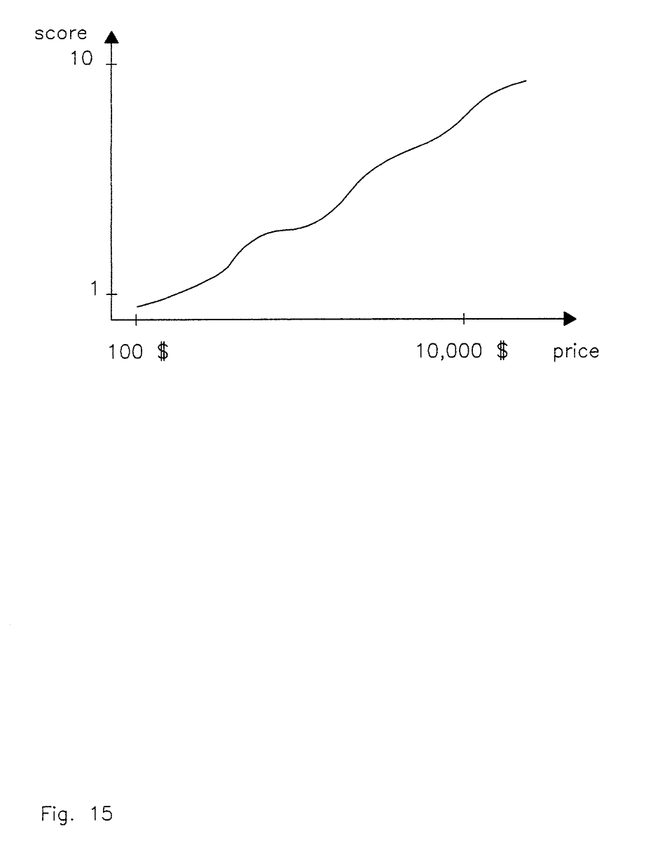

FIG. 15 shows, that the scores or marks can graphically be presented in the context of the price of the job. The buyer may then see that, e.g., he may get better results the more he pays.

The invention will now give an example of how the knowledge marketplace system may evaluate, assess and present the scores of a seller or a buyer, provided as a result of the system-driven evaluation system.

J. Example of an Evaluation System for a Information Product Marketplace (in 11 Chapters)

As described above, the information product marketplace network or system consists of system server 100 (connecting and clearing facility), a pool of knowledge or information product sellers and buyers who are known to and communicate with the system operator and databases that reflect the experience in use of the system by the knowledge or information product sellers and buyers. These sellers and buyers are the participants in the network.

One objective of this invention is to find a system for assessment of the participants (buyers and sellers) by reason of their activity within the framework of the knowledge network system. Under the term assessment, we define an evaluation range for a given scale or dimension of evaluation. For example, the system could use a range of marks from 1 (poorest mark) to 10 (best mark) for determination of one or more dimensions of quality of the service or activities performed by a participant in the network. One requirement is a clear-cut design of the assessment procedures (scoring or marking). This task may be solved by application of various statistical procedures.

The assessment serves to influence the price guidelines for the traded knowledge. It will create stimulus for both seller and buyer to perform high-quality service. At the same time, it will influence the remuneration by the network agency. The following eleven chapters address various aspects of the evaluation systems, including an exemplary organization of data in the database files and methods of processing the evaluation data and related data.

Chapter 1: Assessment and data influencing evaluation

Scale of marks:

The scale of marks will be a cardinal (metric) scale with a defined spacing of the values. For instance the distance of neighbouring marks is equal to 1 and the largest distance is equal to 9. The scale of marks could also be read only ordinally by implying a determined order of precedence:

1<2<3<4<5<6<7<8<9<10

where 1 is poorer than 2, 9 is better than 6, etc. This would, however, limit the possibilities of a differentiated assessment to a large extent. Although you would be able to assign to the numbers concepts of precedence (e.g. extremely bad, very bad, bad, nearly satisfactory, still satisfactory, satisfactory, still good, good, very good, excellent) to support imagination, it would become evident that spacings between these values have no importance or are very difficult to determine or to be objectified. You would have to abstain from averaging.

Types of marks:

First there are data which will actually influence the price structuring by sellers, but these will be (relatively) independent from the participants' quality (such as difficulty and extent of the presented enquiry or desired information product). They determine a certain price limit which is stated in any current or newly created seller's tariff, not further defined here. Such data will therefore not be included into the marking.

Then there are those data which are related to the quality of prior performance of the participants (reputation, competency, qualification, experience) which normally reflect the participant's quality of performance to be expected and are assessed in the form of a relative marking or “rank marks”. Rank marks are time-varying, because they are developed as a participant issues or takes in new enquiry orders, corresponding to information product transactions to be performed, and as a result of evaluation data received by the system in connection with each order or transaction. That is, the rank marks are intended to show accumulated evaluation experience. Various statistical methods can be used to interpret and present this accumulated evaluation experience

Finally, there are data that evaluate the actual quality of the participants during a defined information product transaction or order. These data are involved in the “order marks”.

It is reasonable to form the rank marks or rank scores from the order marks present at any time on the theory that they have predictive (prognosis) value. For this purpose, the scope and age of the orders are to be considered in suitable manner. Prior to the first order, a rank mark is estimated or defined (repute/competency outside the network, when information is missing, e.g., mark 6). The rank marks are to have a relatively high stability, i.e. not substantially depend upon some few order marks). Moreover, they should be included into the price expectations of the participants (quotation, costs estimate). The order marks will usually be more widely dispersed. They are subject to many accidental variations, but will assess the result of the activity of the participants during the order (independently from the past history).

To avoid large variations from the expected prices, in one embodiment, the invoice mark will be determined from participant's rank mark and order mark by taking the appropriately weighted mean value of the two. In another embodiment the invoice mark is simply an after-the-fact evaluation of a seller's or a buyer's satisfaction with the previously agreed pricing, IN a different embodiment, the invoice mark can actually be used to help determine the price to be paid. For example, the buyer and seller might have a defined price limitation but agree to adjustment within a band around that limitation, based on their respective invoice marks. For example, the amount of invoice may be calculated from the defined price limitation and the utilization of both invoice marks provided following the order (invoice mark of the seller and of the buyer) to determine the direction and amount of a percentage adjustment to the defined price limitation..

Influencing quantities:

The denomination of the influencing quantities for the assessment, their weighing and dependencies are not within the field of mathematics or statistics. Only those quantities which are obvious are mentioned below and which are to be defined further or to be supplemented.

Dependency of the marking of the seller upon the buyer's satisfaction as regarding a certain performance (order mark). Such may involve

duration of handling

personal importance of the subject matter (of the problem requested to solve)

results, usefulness, gain of information

fulfilment of personal expectations

Dependency of the marking of the buyer upon the seller's perception of quality of the order specifying a desired performance or information product (order mark). Such may involve

accuracy of problem definition (lack of ambiguity, clearness of understanding)

extent of the supplied background information

Dependency of the marking of the participant (rank mark)

upon the past history (number and scope of previous orders/information product transactions within the network, their distribution in time and their marks)

Chapter 2: Network agency and their data

The marketplace operator will organize the information product transactions managed within the network. It will:

control the enrolling of participants (seller and buyer) into the network

administrate the

pool of sellers (special subjects, competency/marking)

pool of buyers (expectations, problem fields, competency/marking)

connect buyers to sellers (facilitate communication, negotiation and agreements for orders; collect evaluation data) with the help of

questionnaires for specifying the enquiry or requested problem to be solved, defining the desired degree of specialisation and price proposals,

assessment of the enquiry questionnaires and follow-up queries, if any

forms for receiving evaluation data

calculate and raise

the system's own fees

fees of the sellers

The following information is to be collected and administered in a data bank:

Identification numbers for proper arrangement and easy assignability of orders, seller and buyer (order numbers, seller numbers, buyer numbers)

For this purpose, natural numbers are used. When using electronic data processing, they can be suitably encoded. The number of order numbers (referred to as k below) will, of course, be variable and depend upon time. Then, to simplify the matter, it is assumed that the information product order of a buyer is carried out by one seller only, which will not always correspond to current practice. Then there are the following other possibilities:

1. The order is subdivided into several orders which can be assigned each to one individual seller. All of these sellers, however, will have to already belong to the network or be enrolled into it.

2. The order is assigned to one main seller who has further consultants work for him.

Then he must be aware that the order marks will not only reflect his own performance capacity but also that of the other consultants.

3. One consultant is principally substituted by a group of consultants. The order marks will be group notes, of course.

Recording of time(s) for the handling of orders (time stamp)

A continuous metric time scale t≧0 is assumed. The network or system activities will start at the moment t=0. A suitable time unit has to be determined (such as a month, or a day, a term, a year will be possible). Time t=1 means month or day, term, year 1 after starting the marketplace system. Since the completion of an order can take a larger period, the allocation of the point of time is not always unambiguous. Therefore additional conditions may exist (choice of that time unit in which the order is placed; choice of that time unit during which the consultative product is submitted; choice of that time unit which is in the middle of the interval of order handling). Several orders can even have the same handling moment or time stamp. Their ordering will then result from the different order numbers which may be staggered according to the receipt of orders. The sorting of the orders according to order numbers and not according to handling time will simplify both the data structure and the formula for the calculation of the rank marks. It may be reasonable or necessary for certain purposes, however, to file according to time of handling as recorded (also refer to chapter 8: Development of Marks as time series).

Weighting of order

An order or information product enquiry can be very simple. It is possible that the seller can answer in few sentences without the help of extensive research. But it can also be very complex. It can be subdivided into partial orders. Several research projects may to be required. The completion of the order may take a certain time (such as several months). The mark of such an order will generally receive a higher weighting within the framework of the determination of the rank mark. Therefore it will be sensible to introduce order weights. If such is not desired, however, the order weights will all be set to 1. Order weights are positive numbers which are not too large. In general, a discrete scale with a constant incremental spacing (such as 0.1).

Marks (rank marks and order marks of the participants of the network)

The base will be the tens scale. Since the calculation of rank marks is subject to averaging, values out of the interval [1,10] will be produced which are usually not integer. It may be considered to round these values off to again be an integer mark or tenths may be admitted for more finely differentiated operation (as in the tables below). Invoice marks can, but need not be registered separately, since they will result from the rank marks and order marks in unambiguous way (also refer to chapter 4). The process of mark “ageing” will also follow a certain specification. Therefore it is not registered along with the source data (also refer to chapters 3 and 5). The fictitious listings mentioned below will give an outline of the data structures to be administered.

List of orders of the commissioning agency:

Feature of order: order number

Partial lists:

List {L₁(V), . . . , Lₖ(VI)} of the order numbers

List {t₁(V), . . . , tₖ(V)} of the points of time of handling

List {g₁(V), . . . , gₖ(V)} of the order weights

List {A₁(V), . . . , Aₖ(V)} of the numbers of the seller

List {M₁^{A}(V), . . . , Mₖ^{A}(V)} of the sellers' rank marks

List {N₁^{A}(V), . . . , Nₖ^{A}(V)} of the sellers' order marks

List {K₁(V), . . . , Kₖ(V)} of the numbers of the buyers

List {M₁^{K}(V), . . . , Mₖ^{K}(V)} of the buyers' rank marks

List {N₁^{K}(V), . . . , Nₖ^{K}(V)} of the buyers' order marks

TABLE

| Order | 00001 | 00002 | 00003 | 00004 | 00005 | 00006 | . . . |
|---|---|---|---|---|---|---|---|
| Time | 02.00 | 02.00 | 02.00 | 03.00 | 03.00 | 04.00 | . . . |
| stamp | | | | | | | |
| Weight- | 01 | 05 | 02 | 01 | 11 | 03 | . . . |
| ing | | | | | | | |
| Con- | 003 | 212 | 163 | 054 | 007 | 163 | . . . |
| sultant | | | | | | | |
| Rank | 5.7 | 6.3 | 8.1 | 4.3 | 7.5 | 8.4 | . . . |
| mark | | | | | | | |
| Order | 6.2 | 5.9 | 8.7 | 5.4 | 6.1 | 7.8 | . . . |
| mark | | | | | | | |
| Client | 099 | 143 | 254 | 176 | 013 | 085 | . . . |
| Rank | 4.1 | 7.3 | 7.8 | 3.7 | 8.1 | 7.4 | . . . |
| mark | | | | | | | |
| Order | 6.9 | 6.7 | 9.2 | 5.6 | 7.8 | 7.2 | . . . |
| mark | | | | | | | |

List of sellers in the marketplace system:

In the list of sellers, the sellers are filed along with their data by order number, one after the other (i=1, . . . , I). It is a restructured extract from the list of orders. The partial list of a sellers is filed according to number and will contain:

Name of seller with its participant number A₁:

List {L₁(Aᵢ), . . . , Lₘ(Aᵢ)} of the order numbers

List {t₁(Aᵢ), . . . , gₘ(Aᵢ)} of the points of time of handling

List {g₁(Aᵢ), . . . , gₘ(Aᵢ)} of the order weighting

List {M₁(Aᵢ), . . . , Mₘ(Aᵢ)} of the rank marks

List {N₁(Aᵢ), . . . , Nₘ(Aᵢ)} of the order marks

Example: Seller with name “Friese”, Number 163:

TABLE

| | | | |
|---|---|---|---|
| Order | 00003 | 00006 | 00043 |
| Time stamp | 02.00 | 04.00 | 06.00 |
| Weighting | 3.9 | 12.1 | 5.7 |
| Rank mark | 8.1 | 8.4 | 8.1 |
| Order mark | 8.7 | 7.8 | 7.6 |

List of buyers in the marketplace system:

In the list of buyers, the buyers are filed along with their data by order number, one after the other (j=1, . . . , J). It is a restructured extract from the list of orders. The partial list of a buyer will contain:

Name of buyer with its participant number Kⱼ:

List {L₁(Kⱼ), . . . , Lₙ(Kⱼ)} of the order numbers

List {t₁(Kⱼ), . . . , tₙ(Kⱼ)} of the points of time of handling

List {g₁(Kⱼ), . . . , gₙ(Kⱼ)} of the order weightings

List {M₁(Kⱼ), . . . , Mₙ(Kⱼ)}of the rank marks

List {N₁(Kⱼ), . . . ,NₙKⱼ)} of the order marks

Example: Buyer with name “Pistor”, Number 254:

TABLE

| | | | |
|---|---|---|---|
| Order | 00003 | 00039 | 00147 |
| Time stamp | 02.00 | 06.00 | 11.00 |
| Weighting | 3.5 | 1.0 | 2.0 |
| Rank mark | 7.8 | 8.5 | 7.8 |
| Order mark | 9.2 | 7.1 | 8.3 |

Arguments and indices on list elements can be omitted if no misinterpretation can result from this omission. For instance, the order number L₁(V) is usually different from L₁(A₁). Equally the rank mark M₁^{A}(V) can be distinguished from M₁(A₁).

If one of the lists mentioned above is to be arranged according to points in time, one point in time usually includes a set of orders. So it will also include several columns from the related tables.

Chapter 3: Rank Marks

Clear-cut design/clarity of the marking for the sellers may have priority over objectivity/fairness of classification. In one embodiment, the seller may be able to calculate the mark or score himself without difficulty.

The establishment of marks for sellers and buyers can be carried out in similar manner. We explain the procedure here for the sellers. For determination of the rank mark of seller A(i) for the (m+1)-th order (after the m-th order) the following data are used:

List {t₁(Aᵢ), . . . , tₘ(Aᵢ)} of the points of time of handling

List {g₁(Aᵢ), . . . , gₘ(Aᵢ)} of the order weightings

List {N₁(Aᵢ), . . . , Nₘ(Aᵢ)} of the order marks

In addition, a specification for greater weighting of the current order marks is included.

Mark or score ageing: Introduction of a function a(s, t) for description of the ageing or decay process, which will give the more recent order marks greater weight than older ones. It has the following general properties:

a(s,t)≧0 for every 0≦s≦t and t>0

a(s,t)=1 for t>0

a(s,t) is monotonously increasing in s for a fixed t

The variable t≧0 represents the actual time (and also the time having already passed since the start of the network t=0). The variable s∈(0,t] describes the previous periods of time. The number a(s, t) is the weighing factor by which a mark from the period s at the time t≧s is multiplied. Since it describes the decay of the value of the mark, it is also called the decay weighting. The factor a(s,t)=1 will mean no ageing as to the period s (full value of the mark), the factor a(s,t)=0 will mean completely aged (value of the mark is decayed). The remaining factors from the interval [0, 1] will result in intermediate stages. The actual weighting factor a(t, t) will always equal 1. For the previous periods s, the weighting factor does not increase, and generally even decreases (progressive ageing).

The formula for the determination of the rank mark at the time t≧tₘ after completion of the order by the number Lₘ uses the following:

Series (tₗ)=(tₗ(Aᵢ)) for l=1, . . . , m

Series (gₗ)=(gₗ(Aᵢ)) for l=1, . . . , m

Series (Nₗ)=(Nₗ(Aᵢ)) for l=1, . . . , m

Series (aₗ(t))=(a(tₗ,t)) for l=1, . . . , m

At the same time, the series of the ageing weightings is monotonously rising for a fixed t. The values of their terms are within the interval [0,1]. For weighing the order marks, there are several possibilities.

1. Weighted averaging of marks or scores:

The order marks are weighted with the extent of the orders and the decay factors and then averaged. The formula for the rank mark will accordingly be as follows:

$${M}_{m} ( t ) = {M}_{m} ( t , {A}_{t} ) = r d ( \frac{{\sum }_{l = 1}^{m} {a}_{l} ( t ) {g}_{l} {N}_{l}}{{\sum }_{l = 1}^{m} {a}_{l} ( t ) {g}_{l}} ) \qquad ( 1 )$$

Conclusion:

The rank mark is determined as a prognosis from the weighted means (averages) of the order marks. The operation rd means a rounding off to the (differentiated) scale of marks, in this case to integer tenths. The partial weightings aₗ(t) and gₗ of the marks Nₗ can be summed up to the total weightings vₗ(t)=aₗ(t)gₗ. The evaluation will usually require m calculations of function value for the decay factors, 2m each of additions and multiplications, 1 division and 1 rounding off. In another notation you obtain

$${M}_{m} ( t ) = r d ( {\sum }_{l = 1}^{m} {w}_{l} ( t ) {N}_{l} ) , {w}_{l} ( t ) = \frac{{a}_{l} ( t ) {g}_{l}}{{\sum }_{p = 1}^{m} {a}_{p} ( t ) {g}_{p}}$$

where the numbers w(t) are the relative total weightings of the marks Nₗ. They are ranged between 0 and 1 and their sum is equal to 1. For identical order weightings it will form moreover, a monotonous series. For the modified formula, m function value calculations and additions each are required, 2m multiplications, m divisions and 1 rounding off. In every case, the calculating expenditure will usually rise linear with m. The aforementioned formula also contains as a special case all of the simplifications where orders and previous marks are registered as completely equal in weight or where the past history is completely ignored. Calculation expenditure will be accordingly lower.

Important special cases:

a) all order weightings are equal to 1 (no weighting of orders)

$${M}_{m} ( t ) = {M}_{m} ( t , {A}_{t} ) = r d ( \frac{{\sum }_{l = 1}^{m} {a}_{l} ( t ) {N}_{l}}{{\sum }_{l = 1}^{m} {a}_{l} ( t )} )$$

b) all decay weightings are equal to 1 (no ageing of marks)

$${M}_{m} ( t ) = {M}_{m} ( t , {A}_{t} ) = r d ( \frac{{\sum }_{l = 1}^{m} {g}_{l} {N}_{l}}{{\sum }_{l = 1}^{m} {g}_{l}} )$$

c) all total weightings (e.g. all order and decay weightings) are equal to 1:

$${M}_{m} ( t ) = {M}_{m} ( t , {A}_{t} ) = r d ( \frac{1}{m} {\sum }_{l = 1}^{m} {N}_{l} )$$

d) the decay weightings are equal to 0 except for the last k (only the last k orders will count):

$${M}_{m} ( t ) = {M}_{m} ( t , {A}_{t} ) = r d ( \frac{{\sum }_{l = m - k + 1}^{m} {a}_{l} ( t ) {g}_{l} {N}_{l}}{{\sum }_{l = m - k + 1}^{m} {a}_{l} ( t ) {g}_{l}} )$$

Strictly speaking, this formula has no other sense but for m≧k. With the sum convention Σₗ₌ₜ^{m} . . . =Σ_{l=max(t,1)}^{m} . . . it will be also apply for m<k.

e) all decay weightings are equal to 0 except for the last (only the last order is counted, k=1):

Mₘ(t)=Mₘ(t, Aₗ)=rd(Nₘ)=Nₘ

f) all decay weightings are equal to 0, which are outside a fixed period window [tₘ−tᵥ,tₘ] (fixed decay period tᵥ):

$${M}_{m} ( t ) = {M}_{m} ( t , {A}_{t} ) = r d ( \frac{{\sum }_{l {t}_{l} ∈ [ {t}_{m} - {t}_{v} , {t}_{m} ]}^{m} {a}_{l} ( t ) {g}_{l} {N}_{l}}{{\sum }_{l : {t}_{l} ∈ [ {t}_{m} - {t}_{v} , {t}_{m} ]}^{m} {a}_{l} ( t ) {g}_{l}} )$$

The rank mark Mₘ(t) is a rounded off convex average of the order marks. Therefore it will be again within the field [1,10] and be a prognosis value (for the period t). More precisely, the limits

Nₘᵢₙ≦Mₘ(t)≦Nₘₐₓ

Where

Nₘᵢₙ=min {N₁, . . . , Nₘ}, Nₘₐₓ=max {N₁, . . . , Nₘ}.

This rank mark will be stated to the client upon his order with the number Lₘ₊₁ after the choice of a suitable period of time t=t*∈[tₘ, tₘ₊₁]:

Mₘ₊₁=Mₘ(t*).

If a time t=tₘ is assumed when determining the rank marks, the past history will be considered up to the moment tₘ, but not the period until the point of time tₘ₊₁ of the current order. On the other hand, the rank mark will remain unchanged and can be communicated to the client all at once. The choice of t=tₘ₊₁ will perhaps reflect the circumstances better, but it has to be recalculated at that moment. If the period tₘ₊₁=tₘ is small, the difference between the marks is unimportant. There are functions a(s, t) for which Mₘ(tₘ)=Mₘ(tₘ₊₁) applies. If functions of a(s,t) are used with fixed finite period of decay (also refer to chapter 5), then possibly less order marks will be considered for the use of Mₘ(tₘ₊₁) than when using Mₘ(tₘ). Then depending on each assignment of marks, Mₘ(tₘ₊₁) can be greater or less than Mₘ(tₘ). If the order marks become finally better, an improvement of the marks will occur during longer break periods of orders, in the other case a deterioration of marks. If the first effect is desired to be avoided, then break periods of orders can be provided with a penalty function b(t, u) which is equal to 1 for u=t and will drop monotonously for u>t:

M*ₘ₊₁=rd(Mₘ₊₁b(tₘ,tₘ₊₁)). (2)

Such a punishment would motivate the consultant (sellers) to work regularly. Another possibility would be to determine rank marks in regular intervals. If then no new order marks exist, the corresponding rank marks will be entered into the formula, instead of the missing order marks. But even here the negative effect as described above can occur, which can be subject to penalty in a similar manner. The procedure of determining the marks is relatively inertly as compared to alterations, when there are many marks to consider.

2. Approximation, Regression:

The following approach is highly suitable for the better consideration of current trends. We look at the data record

(tₗ, Nₗ) (l=1, . . . , m)

of the development of the marks of seller Aᵢ. We have to be aware here of the fact that the series (t1) of the order periods is not generally bound to rise monotonously. In particular, equal periods tₗ can belong to different orders l. If such an effect is undesirable, it can be avoided (also refer to chapter 8). The weightings (order weighting, decay weightings) can first be neglected. Now it is possible to look from one class of suitable time functions with the parameter vector \vec{c}=(c₁, . . . cₙ) for such functions

f(t,\vec{c})=f(t,c₁, . . . , cₙ)

which fit best to this data record (approximation, parameter optimisation). Then there is the chance to establish a prognosis of marks for any arbitrary period t, too. The approximation procedure will also generally involve a smoothing process which will compensate for accidental deviations. Usually the method of the discrete root mean square approximation (MKQ, Gaussian method of least squares, in statistics also called regression) is used which will normally furnish a unique solution for the case of n<m (less parameters than marks). When including the weightings wₗ=w(gₗ,aₗ(t*)), t*∈[tₘ, tₘ₊₁], which consider the order weightings and equally the procedure of ageing of the marks, the condition for approximation will be the following:

$$S ( \vec{c} ) = {\sum }_{l = 1}^{m} {{w}_{l} ( f ( {t}_{l} , \vec{c} ) - {N}_{l} )}^{2} \to min .$$

All marks with high order weighting gₗ and which are of a recent date must accordingly receive a high weighting wₗ. Then the approximation mark will be particularly close to the corresponding order mark. In the easiest case, you can select

wₗ=aₗ(t*)gₗ

When the parameter vector \vec{c}* is determined from this condition, then the corresponding rounded off optimum function of the class, will become the rank mark depending on the time t as a result (prognosis value for the time t≧tₘ):

Mₘ(t)=rd(f(t,\vec{c}*)). (3)

Then, in particular,

Mₘ₊₁=Mₘ(t*)=rd(f(t*,\vec{c}*)), t*∈[tₘ,tₘ₊₁].

If the optimum function value exceeds the maximum mark 10, then round off to 10 (round down). In the easiest case, you can assume the class of the constant functions as:

f(t,c)=c, c is real.

Then the following solution will be produced:

$${M}_{m + 1} = {M}_{m} ( {t}^{*} , {A}_{t} ) = {c}^{*} = r d ( \frac{{\sum }_{l = 1}^{m} {w}_{l} {N}_{l}}{{\sum }_{l = 1}^{m} {w}_{l}} )$$

This is precisely the general formula of the weighted mark averaging (refer to equation (1)) for the weightings wₗ=aₗ(t*)gₗ. In this respect, the way studied here is a generalization of the first one. The next easier statement will utilize the class of linear functions:

f(t,c₁,c₂)=c₁+c₂t.

For calculating c₁* and c₂* there are plain formulas existing. This approach is called linear regression in statistics. The statements mentioned above will, however, only be reasonable (will avoid larger errors) if the marks actually follow a certain constant or linear trend, except for some minor deviations which are rather accidental (approximately constant quality of order handling, quality with a linear upward or downward trend). It is possible that such approaches will be only applicable for certain phases. Then they can, however, be used for reliable prognoses for these phases. For the order Lₘ₊₁ then again t=tₖ or t=tₖ₊₁ can be assumed (also refer to discussion above). The later value will have the following disadvantage to a greater extent than even for the averaging of the marks: If an unmistakable upward trend exists in the marks, the value of prognosis will be even higher after a longer waiting period. So the seller just has to handle no orders in the network for a sufficiently long period of time in order to obtain rank mark 10. He will, of course, not earn anything during this time and perhaps will not be permitted by the system to take orders any longer if the rank marks are too high. Apart from that, the modified formula (2) with penalty function can be used again:

Mₘ₊₁=rd((f(t*,\vec{c}*)b(tₘ,tₘ₊₁)).

The models shown above provide a large clearance for the assignment of marks. Therefore it will be reasonable to investigate the influence of the parameter specification upon the forming of marks (and thus upon the amount of the invoice). In particular, by defining a calculation model depending on parameters, these parameters can be optimised in such a way that the deviation between order and rank marks will become as low as possible.

Note: If no significant differences (or disadvantages for the involved persons) become obvious, the simpler methods are to prefer.

It is actually a fact that computing times are probably not substantially higher with the more complex models, due to the advanced computing technology. In any case, however, the expenditure for data maintenance resulting each time must be considered.

Chapter: 4 Order and invoice marks

For the determination of the seller's order mark or score, the buyer has to fill in a questionnaire (electronic), i.e., personal interview in writing) which is suitably developed by persons skilled in the art of surveys. For the individual questions, discrete estimator scales exist (such as the decimal scale, for instance, or for simplification, only a triple scale or a five-unit scale), in which the buyer has to check off a certain box. To help a respondent's thinking, these cardinal values can be associated with verbal descriptions (assignment to an ordinal scale):

Triple scale: good, satisfactory, poor

Five-unit scale: very good, good, satisfactory, poor, very poor

The box cross marking will relate to a marking of certain dimensions or scales for evaluation of the information product transaction. If marking any box by cross is omitted (e.g. forgotten), the questionnaire can be directly returned, or the missing cross marking be punished (set the highest mark to the participant's disadvantage: the 3 when using the triple scale).

The aspects will get weightings according to their importance for the quality of consultation. Such a determination of the weightings, however, will be beyond the mathematical field. In a field test, for instance, participants may estimate partial marks or total marks (order marks) during an initial phase or preliminary phase. These data can be used for weighting with statistic means (e.g., multilinear regression) and then used during the actual phase. The weighted average of these partial marks will become, as a result after transformation of the internal scale to the decimal scale, the order mark. The formula is as follows:

$$N ( 10 ) = \frac{9}{k - 1} N ( k ) + 1 ,$$

if N(10) represents the mark on the decimal scale and N(k) the mark on the internal scale with k values.

### Example: Questionnaire (fictitious):

| Questions | Weighting | 1 Point | 2 Points | 3 Points | Products |
|---|---|---|---|---|---|
| Question 1 | 3 | | X | | 6 |
| Question 2 | | X | | 4 | |
| Question 3 | 1 | x | | | 1 |
| Question 4 | 1 | | | x | 3 |
| Question 5 | 1 | | X | | 2 |
| Sum | 8 | | | | 16 |

Therefore,

$$N ( 3 ) = \frac{16}{8} = 2 , \text{and} N ( 10 ) = \frac{9}{2} N ( 3 ) + 1 = 5.5$$

In the decimal scale, you will receive the order mark 5.5 (or order score).

The formula for determination of the seller's invoice mark Rₘ₊₁, as soon as the buyer's order mark Nₘ₊₁ has been obtained, will be as follows:

Rₘ₊₁=cMₘ₊₁+dNₘ₊₁, c≧0, d≧0, c+d=1 (4)

Chapter 5: Ageing of Marks

As mentioned above, it is sensible to assign marks or scores from older orders less weight than more recent marks when determining the rank marks. For the purpose of modelling of such ageing of marks or decay of marks, we will use the functions a(s, t) as described in chapter 3, which we also call retrogressive decay processes. The name retrogressive (back view) is used because the decay will occur backwards from the current time t to passed times s.

Definition:

If for a given t a smallest value tₕ=tₕ(t) exists, with

$$a ( t - {t}_{h} , t ) = \frac{1}{2}$$

it is called half-value period. The value tₕ is the (period of) time from t backwards into the past, which (for the first time) has led to a midline section of the value of the mark. If there is a smallest value tᵥ=tᵥ(t) for a given t, with

a(t−tᵥ,t)=0

it is called decay period. The value tᵥ is the (period of) time from t backwards into the past, which (for the first time) has led to a complete loss of the value of the mark. The decay index i=s(t) is the quotient from the decay factors of two periods s−1 and s following each other (as seen from the current time t):

$$i ( s , t ) = \frac{a ( s - 1 , t )}{a ( s , t )} , s \geq 1.$$

This index will therefore only exist for a(s,t)>0 and will obviously be between 0 and 1.

The decay velocity at the time s (as seen from the current time t) will be the negative partial differentiation of the decay factor to the time s:

$$v ( s , t ) = - {a}_{s} ( s , t ) = - \frac{\partial }{\partial s} a ( s , t ) .$$

This velocity will only exist on even decay functions. Since a(s, t) is monotonously growing in s, therefore a(s, t)≧0 and v(s,t)≦0. The negative sign indicates the decay.

Classes of decay progress:

a) Extension decay (homogenous decay)

a(γs,γt)=a(s,t) for all γ>0

b) stationary decay (independent from t)

a(s−h,t−h)=a(s,t), h>0, h≦s≦t

Displacement invariance of the curves

c) stationary decay with symmetrical reversal point

a(t−c+u,t)+a(t−c−u,t)=1, 0≦u≦min(c,t−c)

For any c>0 will be additionally to b),

Curve part left-hand from (t−tₕ,a(t−tₕ,t)) point-symmetric to the right-hand part of the curve (tᵥ=2c and tₕ=c).

d) Decay with proportional half-value period and decay period

$${t}_{v} = t , {t}_{h} = \frac{t}{2}$$

Some typical progress examples:

$$\begin{matrix}a ( s , t ) = {( \frac{s}{t} )}^{α} , & α > 0 & \text{power decay} \\ a ( s , t ) = {α}^{s - t} , & α > 0 & \text{exponential decay}\end{matrix}$$

a>0 power decay

a(s,t)=a^{s-t}, a>0 exponential decay

$$a ( s , t ) = \frac{1 - {α}^{- ( s - t ) - {u}_{0}}}{1 - {α}^{- {u}_{0}}} , \qquad α > 0 , {u}_{0} \geq t \qquad \text{inverse exponential decay}$$

a>0, u₀≧t inverse exponential decay a(s,t)=(c(s−t)+1)+, c>0 stationary linear decay (independent from t)

$$a ( s , t ) = \{ \begin{matrix}\frac{1}{2} ( \frac{arctan β ( s - t + {v}_{0} )}{arctan β {v}_{0}} + 1 ) & \text{if} s \geq max ( 0 , t - 2 {v}_{0} ) , β > 0 \\ 0 & \text{or else}\end{matrix}$$

if s≧max (0,t−2v₀), β>0 or else stationary arc tangent decay

$$a ( s , t ) = \frac{1}{2} ( \frac{arctan β ( s - \frac{t}{2} )}{arctan β \frac{t}{2}} + 1 ) , β > 0$$

extended arc tangent decay

$$a ( s , t ) = \{ \begin{matrix}\frac{1}{2} ( \frac{sin β ( s - t + {v}_{0} )}{sin β {v}_{0}} + 1 ) & \text{if} s \geq max ( 0 , t - 2 {v}_{0} ) \\ 0 & \text{or else}\end{matrix}$$

is s≧max (0,t−2v₀) or else

$$β > 0 , {v}_{0} ∈ [ 0 , \frac{π}{2 β} ]$$

stationary sinusoidal decay

$$a ( s , t ) = \frac{1}{2} ( \frac{sin β ( s - \frac{t}{2} )}{sin β \frac{t}{2}} + 1 ) , β > 0$$

extended sinusoidal decay a(s,t) monotonous step function

Now some properties of selected decay progresses are stated:

Power decay:

Extended decay (homogenous decay)

a(0,t)=0, a(s,t) strict monotonously growing in s

a(s,t) continuously (and smooth) in s

Decay period tᵥ=t

Half-value period

$$H a l f \text{-} v a l u e p e r i o d {t}_{h} = ( 1 - {2}^{- \frac{1}{α}} t ) < t$$

Decay index

$$D e c a y i n d e x i ( s , t ) = {( \frac{s - 1}{s} )}^{α}$$

a(s,t) strictly convex (left-hand curvature) for a>1 and strictly concave (right-hand curvature) for

0<a<1.

linear extended decay for a 1

Special case a(s,t)=1 (no decay) for a=0, tᵥ and tₕ do not exist here.

Exponential decay:

stationary decay

a(0,t)>0, a(s,t) strictly monotonously growing in s

a(s,t) continuous (and even) in s

a(s,t) strictly convex (left-hand curved)

Decay period tᵥ does not exist,

half-value period tₕ=ln2/ln a independent from t, for a=2 therefore tₕ=1.

Decay index

$$D e c a y i n d e x i ( s , t ) = \frac{1}{α}$$

independent from s and t

Stationary linear decay:

Stationary decay with symmetric reversal point Decay time tᵥ=1/c,

half-value period tₕ=1/(2c)

Decay velocity v(s,t)=−c for s≧t−1/c

Stationary sinusoidal and arc tangent decay:

Stationary decay with symmetrical reversal point

Extended sinusoidal and arc tangent decay:

decay with proportional half-value and decay period

Chapter 6: Mark rank with weighted averaging

For the calculation and further investigations of the weighted averaging it is sensible to use a compact writing or notation. The (infinite) decay matrix

A=(aₖₗ)_{k≧1, l≧1}

with

$${a}_{k l} = \{ \begin{matrix} {a}_{l} ( {t}_{k}^{*} ) = a ( {t}_{l} , {t}_{k}^{*} ) & fo r l \leq k \\ 0 & fo r l > k\end{matrix} , {t}_{k}^{*} ∈ [ {t}_{k} , {t}_{k + 1} ]$$

is a lower triangular matrix which contains all decay weightings ever required . The main diagonal elements are 1, above them are only zero elements, below are elements between 0 and 1 which are monotonously growing for each line. Although A had first been designed to be time-oriented, it can also be later used as order-oriented for other periods .

The segment matrix

Aₘ=(aₖₗ)_{1≦k,1≦m}

from the first m lines and columns of A will contain as line half-value vectors

\vec{a}ₖ^{T}=(aₖₗ . . . aₖₕ), l≦k≦m

up to the main diagonal exactly the sequential decay weightings of the marks which are present up to order k. Their line summation standards are

$$\vert {\vec{a}}_{k}^{T} {\vert}_{1} = {\sum }_{l = 1}^{k} {a}_{k l } .$$

The decay matrix will be, along with the diagonal matrix G of the order weightings, containing the elements

$${g}_{k l} = \{ \begin{matrix}{g}_{l} & for k = l \\ 0 & for k \neq l\end{matrix} ,$$

the weighting matrix

V=AG,

with the last line half vector

\vec{v}ₘ^{T}=(vₘₗ . . . vₘₘ)=\vec{a}ₘ^{T}Gₘ

The matrix v is again a lower triangular matrix. If \vec{N} is the vector whose segment \vec{N}ₘ from the first m coordinates will contain exactly the first m order marks, then the respective rank mark will result from

$${M}_{m + 1} = r d ( \frac{{\vec{v}}_{m}^{T} {\vec{N}}_{m}}{\vert {\vec{v}}_{m}^{T} {\vert}_{1}} ) . \qquad ( 5 )$$

If then additionally the matrix w of the relative weights with the elements

$${w}_{k l} = \frac{{v}_{k l}}{\vert {\vec{v}}_{k}^{T} {\vert}_{1}}$$

is introduced, then also

Mₘ₊₁=rd(\vec{w}ₘ^{T}\vec{N}ₘ).

will be valid.

Now special cases are considered which will significantly reduce the computing expenditure for rank mark determination.

Recursive decay matrices:

In the most simple case, for instance, will be

aₘₗ=γₘ₋₁a_{m-1,l}, γₘ₋₁∈[0,1] for m≧2, l<m

aₘₘ=1 for m≧1.

The new half line of A results from the preceding half line multiplied with a number between 0 and 1, supplemented by the last element 1:

\vec{a}ₘ^{T}=(γₘ₋₁ \vec{a}ₘ₋₁^{T} 1).

This condition will also ensure that A is a decay matrix. If you select

γₘ₋₁=γ∈(0,1)

then

\vec{a}ₘ^{T}=(γ^{m-1} . . . γl)

The respective matrix A is created by the exponential decay function

a(s,t)=a^{s-t}

for a=γ⁻¹ and the constant time sequence tₗ=l. The rank mark Mₘ is calculated according to (5) from a quotient

$${M}_{m} = \frac{{M}_{m}^{Z}}{{M}_{m}^{N}}$$

Then the next rank mark results recursively simply from

$${M}_{m + 1} = r d ( \frac{{γ}_{m - 1} {M}_{m}^{Z} + {g}_{m} {N}_{m}}{{γ}_{m - 1} {M}_{m}^{N} + {g}_{m}} ) .$$

Generally it is quite improbable that the relative weighting matrix W shows a similarly plain structure, because the weighting values cannot be controlled in advance. But if there is a situation where these weightings can be set equal to 1, then W has an analogous structure:

\vec{w}ₘ^{T}=(δₘ₋₁\vec{w}ₘ₋₁^{T}wₘₘ), δₘ₋₁∈(0,0.5).

The recurrence formula for the rank mark will be even easier then:

Mₘ₊₁=rd(δₘ₋₁ Mₘ+wₘₘ Nₘ).

Conclusion:

The computing expenditure for the determination of the rank marks will not rise linearly with growing numbers of orders, but will remain approximately equal on a very low level.

More generally, one can construct decay matrices in which the m-th line will result recursively from several or even from all the preceding lines:

\vec{a}ₘ^{T}=(\vec{γ}ₘ₋₁^{T} Aₘ₋₁ l).

Then

$${M}_{m + 1} = r d ( \frac{{\vec{γ}}_{m - 1}^{T} {\vec{M}}_{m}^{Z} + {g}_{m} {N}_{m}}{{\vec{γ}}_{m - 1}^{T} {\vec{M}}_{m}^{N} + {g}_{m}} )$$

will be valid, with \vec{M}ₘ^{Z} and \vec{M}ₘ^{M} being known from the calculation of the precursor Mₘ. For the unitary order weightings simply

Mₘ₊₁=rd(\vec{δ}ₘ₋₁ \vec{M}ₘ+wₘₘ Nₘ).

will be produced.

Conclusion:

The computing expenditure for the determination of the rank scores or rank marks will again not rise substantially for growing order numbers, if a limited recurrence is present (new line will depend on a fixed number of preceding lines).

Decay matrices with strip structure:

If the elements of A have the property

aₖₗ=0 for k<l≦k−p

with a natural number p, then A is a lower strip matrix with the strip width p. Then the line half vectors \vec{a}ₘ^{T} and \vec{v}ₘ^{T}, which are responsible for the rank determination, will contain at the maximum p and for a higher in precisely p not-zero-elements. The situation will be especially simple if A is only produced by p different decay weightings (a₁ . . . aₚ):

$$A = [ \begin{matrix}{a}_{p} & 0 & ⋯ & 0 & ⋯ & ⋯ \\ {a}_{p - 1} & {a}_{p} & 0 & ⋯ & ⋯ & ⋯ \\ ⋮ & ⋰ & ⋰ & ⋰ & ⋰ & ⋮ \\ {a}_{1} & {a}_{2} & ⋯ & {a}_{p} & 0 & ⋯ \\ 0 & {a}_{1} & {a}_{2} & ⋯ & {a}_{p} & ⋯ \\ ⋰ & ⋰ & ⋰ & ⋰ & ⋰ & ⋰\end{matrix} ]$$

Such matrices have constant strips. You can easily produce them from stationary decay functions a(s,t). For the rank marks, each time only the last p order marks are used.

Conclusion:

The computing expenditure for rank mark determination will be approximately constant despite growing order numbers, if the decay matrix has strip structure.

Chapter 7: Mark rank with approximation

Point of departure will be the data set

(tₗ,Nₗ) (l=1, . . . , m)

of the mark development of the seller A, with the weightings

wₗ (l=1, . . . , m).

We chose the best discrete root mean square approximation (MKQ) from the class of functions

f(t,\vec{c})=f(t,c₁, . . . , cₙ)

with the parameter vector \vec{c}=(c₁, . . . , cₙ) For compact representation, we consider the vector of the function values at the time points

$$\vec{f} ( \vec{c} ) = ( \begin{matrix}f ( {t}_{1} , \vec{c} ) \\ ⋮ \\ f ( {t}_{m} , \vec{c} )\end{matrix} )$$

as well as the diagonal matrix W of the weightings and the mark vector \vec{N}

$$W = ( \begin{matrix}{w}_{1} & 0 & ⋯ & 0 \\ 0 & {w}_{2} & ⋯ & 0 \\ 0 & 0 & ⋰ & 0 \\ 0 & 0 & ⋯ & {w}_{m}\end{matrix} ) , \vec{N} = ( \begin{matrix}{N}_{1} \\ ⋮ \\ {N}_{m}\end{matrix} ) .$$

The optimisation problem will then be:

∥W^{½}(\vec{f}(\vec{c})−\vec{N})∥²→min.

If you chose a linear statement

$$f ( t , \vec{c} ) = {\sum }_{k = 1}^{n} {c}_{k} {f}_{k} ( t )$$

for the unknown parameters, then the vector of the function values has the representation

\vec{f}(\vec{c})=F\vec{c}

with the matrix

$$F = ( \begin{matrix}{f}_{1} ( {t}_{1} ) & ⋯ & {f}_{n} ( {t}_{1} ) \\ {f}_{1} ( {t}_{2} ) & ⋯ & {f}_{n} ( {t}_{2} ) \\ ⋮ & ⋰ & ⋮ \\ {f}_{1} ( {t}_{m} ) & ⋯ & {f}_{n} ( {t}_{m} )\end{matrix} )$$

Then the optimisation structure will have the plain structure

∥W^{½}(F\vec{c}−\vec{N})∥²→min

and will lead to a linear system of equations

F^{T}WF\vec{c}=F^{T}W\vec{N}

with symmetrical coefficient matrix

$$H = {F}^{T} WF = ( {h}_{i k} ) , {h}_{i k} = {\sum }_{l = 1}^{m} {w}_{l} {f}_{i} ( {t}_{l} ) {f}_{k} ( {t}_{l} )$$

and the vector of the right-hand sides

$$p = {F}^{T} W \vec{N} = ( {p}_{i} ) , {p}_{i} = {\sum }_{l = 1}^{m} {w}_{l} {f}_{i} ( {t}_{l} ) {N}_{l}$$

For this linear system of the Gaussian normal equations there are adapted solution approaches. If one selects for the statement functions fₖ(t) powers of t, then the best approximation is to be found in the polynomial field. Often you take cubix splines which are composed of polynomials of third degree. If the data record has a periodical structure, you will use trigonometric functions (Fourier polynomial).

If the system of the Gaussian normal equations has a bad condition (disadvantageous for a numerical solution, high error-rate), you can carry out a suitable regularization with the smoothing matrix M and the regularization parameter a. The modified optimisation task

∥W^{½}(F\vec{c}−\vec{N})∥²+a\vec{c}^{T} M\vec{c}→min

will then lead to a better conditioned linear equation system

(F^{T}WF+aM)\vec{c}=F^{T}W\vec{N},

which then again can be solved with standard methods.

Chapter 8: Mark development as time series

If the development of the marks of one or several participants is intended to be interpreted or represented as time series, the order number, not the time of handling is to be selected as the data base filing feature.

Then we have a (strictly monotonously ranged) list of times

(Tₖ)=(Tₖ(Aᵢ)) for k=1, . . . , q.

Each time can contain a set of orders:

{L_{k,1}, . . . , L_{k,n}_{ₖ}}.

If

{g_{k,1}, . . . , g_{k,n}_{ₖ}}, {N_{k,1}, . . . , L_{k,n}_{ₖ}}

are respective lists of order weightings and order marks, then you can form the averages which are now weighted

$${N}_{k} = r d ( {\sum }_{l = 1}^{{n}_{k}} {w}_{k , l} {N}_{k , l} ) , {w}_{k , l} = \frac{{g}_{k , l}}{{g}_{k}} , {g}_{k} = {\sum }_{p = 1}^{{n}_{k}} {g}_{k , p}$$

You will obtain a time series (Tₖ, Nₖ) with the weightings gₖ(k=1 . . . q). When using respective interpolation and approximation methods, you can even obtain equal distances between the times. Time series and therefore also mark developments can now be studied, processed and represented under different points of view.

Smoothing:

With the help of approximation methods one can approximate a smooth function which will not have any certain accidental deviations, to the (discrete) time series. In the most simple case, these are moving averaging values (refer to mark averaging).

Component decomposition:

There are methods how to decompose time series additively into the (smooth) trend, into cyclical components such as seasonal influences and into a residual component which will reflect accidental influences and represents a random process. These components mentioned can be studied separately and also be extrapolated separately for prognoses.

Prognosis:

The smoothing method mentioned above can also be used for prognosis (refer to rank mark determination).

Chapter 9: Statistic Assessment of the Rank Lists

In the course of time, the marketplace system will accumulate data sets of sellers' and buyers' marks which can be processed and evaluated in manifold ways (table summaries, graphical representation). The evaluation can be used for improving the models for marks computing or for other purposes (exclusion of participants, assignment of sellers to buyers, transfer of processed data to other institutions). We only mention some of the obvious possibilities as follows:

Marks or score summaries (including graphical representation)

of individual participants (development in time, frequency distribution)

of the pool of sellers or of buyers (frequency distribution at certain periods or in general)

Comparison of rank and order marks, parameter optimisation for the computing models for rank marks

Determination of preferences by buyers as regarding certain sellers

Determination of correlation between the order marks of buyers and sellers

Subdivision of the participants into certain groups of performance (clustering)

Chapter 10: Remarks about remuneration

When the marks system has been determined, a method for remuneration of the system operator and sellers can be developed. The following specifications may guide this purpose:

Good enquiry or information product definition by a buyer will reduce the buyer fees

Good answers or information products from a seller will increase the seller remuneration

Good enquiry or information product definition by the buyers and good answers or information products from a seller will reduce remuneration for the system operator

The system can thus define or adopt from participants certain standard pricing schemes. If participants accept these are “par values” for an information product transaction subject to adjustment based on the order marks developed during evaluation, incentives for improved performance by both sellers and buyers can be built into the system. For example, a seller's above average performance might provide a premium multiplier to be applied to a standard or agreed tariff, and a buyer's above average performance might provide a discount multiplier to be applied to a standing tariff. When both buyer and seller perform well, the resulting price may reflect some surrender by the market system of a portion of its remuneration, commensurate with reduced costs or risks to the marketplace operator from a well-defined and performed transaction.

The invention assumes that the mutual assessment of buyer and seller will not be sufficient, even with these specifications, in order to avoid intentional under-assessment of performance, intended to affect price. Moreover, the system may reward consistency of evaluation marks (for instance, consistency of a defined rank mark with an order mark, or the seller's order mark with the seller's self-assessment) in some way to prevent the mentioned effect as far as possible. That is, a statistically credible evaluation might be accepted without adjustment as a factor in determining pricing, whereas, an evaluation that was not statistically credible might be discounted before its application to affect a price calculation.

Chapter 11: Fictitious or Example Application

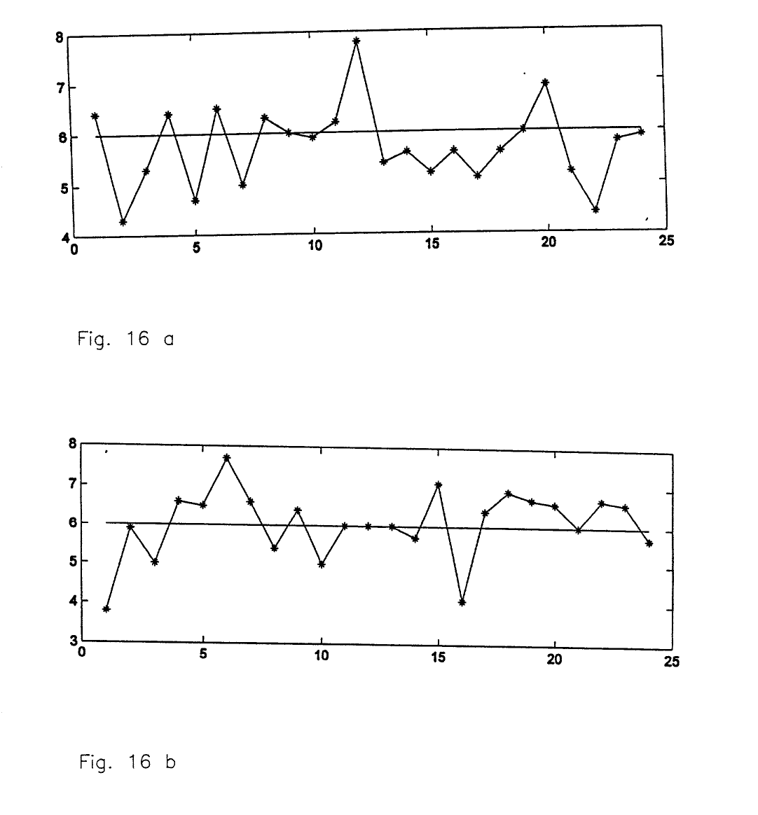

This chapter will comprise some fictitious developments of marks of one participant, which are created with statistical methods as an example how the ranking with different decays, weightings and trends might work. It was assumed that every month an order mark was presented. The development was investigated for two years. The mark series contains a trend (constant or linear), an annual cycle and accidental deviations which are equally or normally distributed. For the determination of the rank marks for the ranges of orders, unitary weightings or random selected weightings from the range 1 to 10 were used. For ageing of marks, several models were used and results are presented in the graphs of FIGS. 16 to 29. In these figures there are shown on the x-axis month and on the y-axis scores or marks. The computing model for rank marks was in each case, however, the weighted averaging of marks. A thorough evaluation will require substantially more data material. But the comparison of order and rank marks will show even here in a significant way the smoothing character of the rank marks.

FIG. 16a. shows the development of marks or scores with a constant trend and equally distributed variation while FIG. 16b. shows it with constant trend and normally distributed variation.

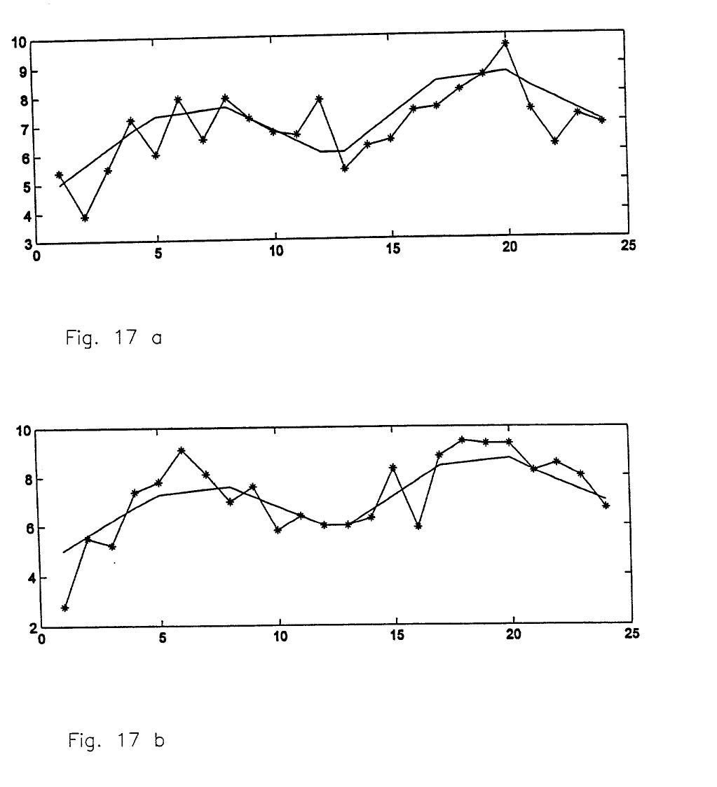

FIG. 17a. shows the development of score or mark with a linear-cyclic trend and equally distributed variation while in FIG. 17b. a linear-cyclic trend with normally distributed variation is shown.

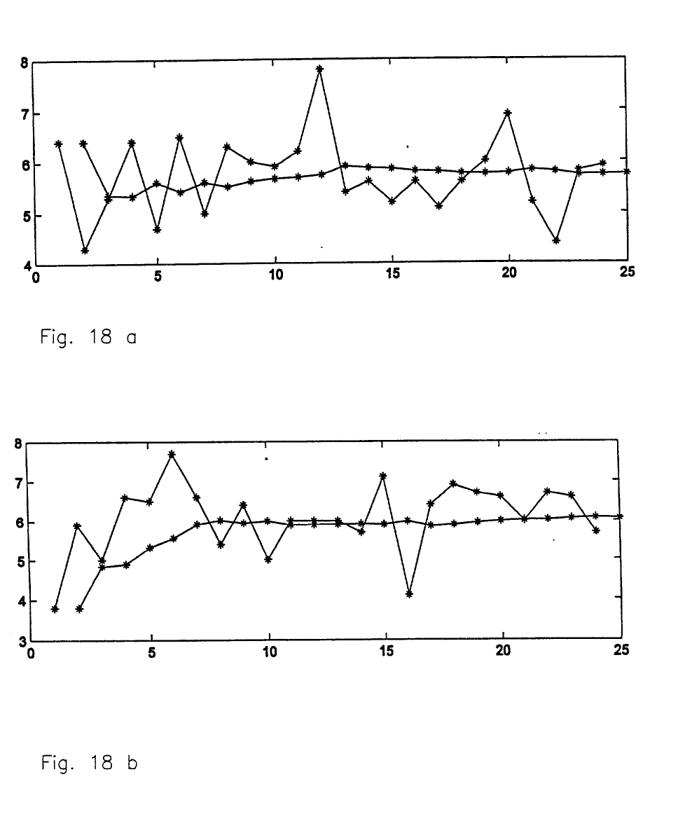

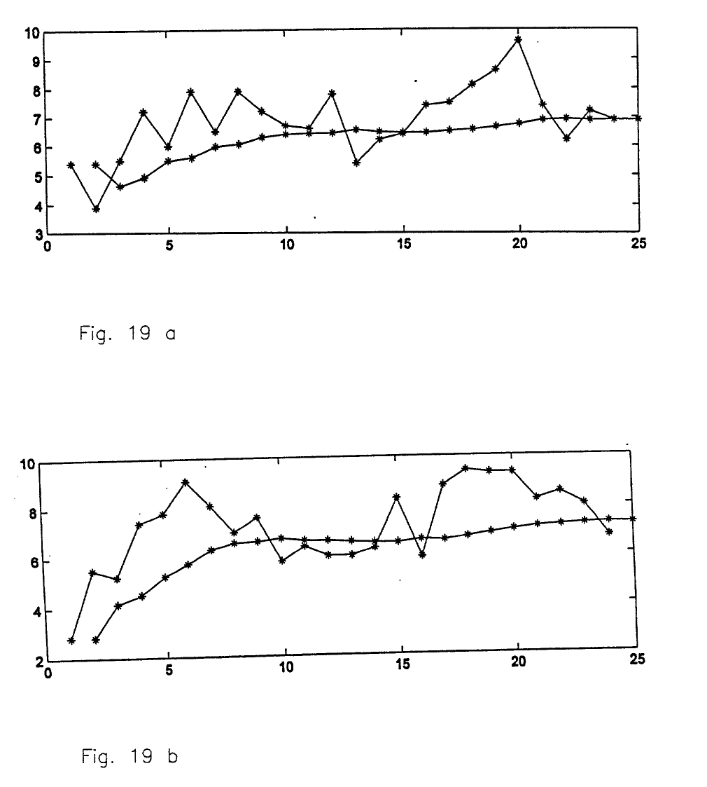

Order marks-rank marks with no decay and unitary weightings are shown in FIG. 18 with constant trend. FIG. 18a. shows an equally distributed variation and FIG. 18b. shows an normally distributed variation. Order marks-rank marks with no decay and unitary weightings are shown in FIG. 19 with linear-cyclic trend. FIG. 19a. shows an equally distributed variation and FIG. 19b. shows an normally distributed variation.

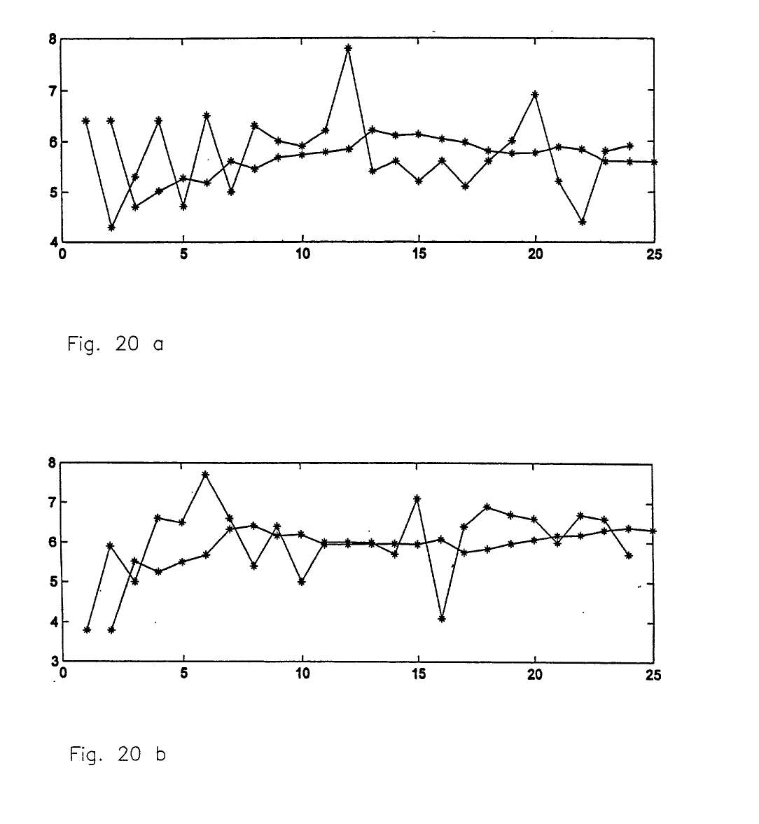

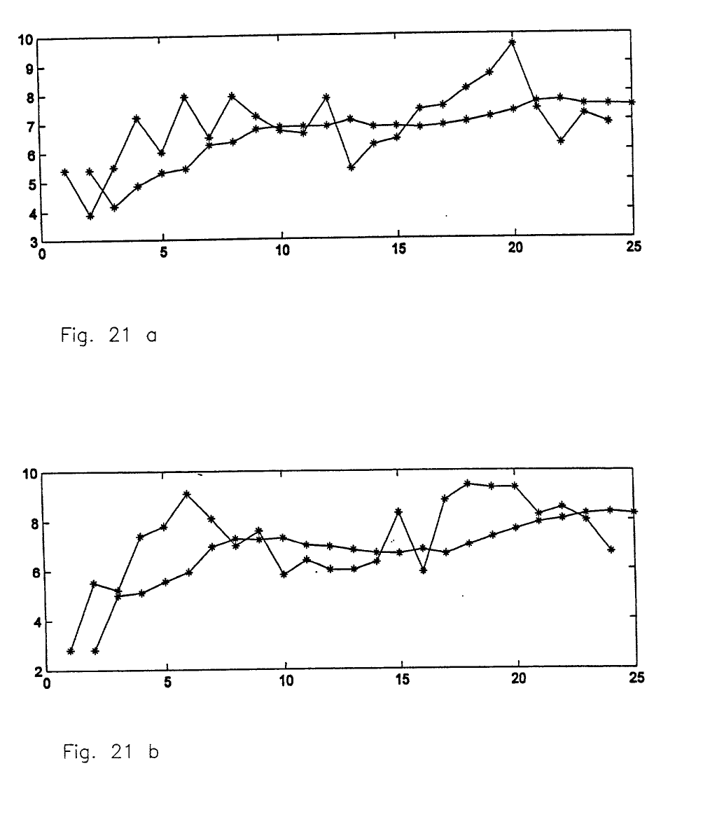

In contrast to FIG. 18 and 19, FIG. 20a. shows order marks-rank marks with linear annual decay and various weightings such as a constant trend and equally distributed variation and normally distributed variation in FIG. 20b. Order marks-rank marks again with linear annual decay but linear-cyclic trend, and equally distributed variation is shown in FIG. 21a. and with normally distributed variation is shown in FIG. 21b.

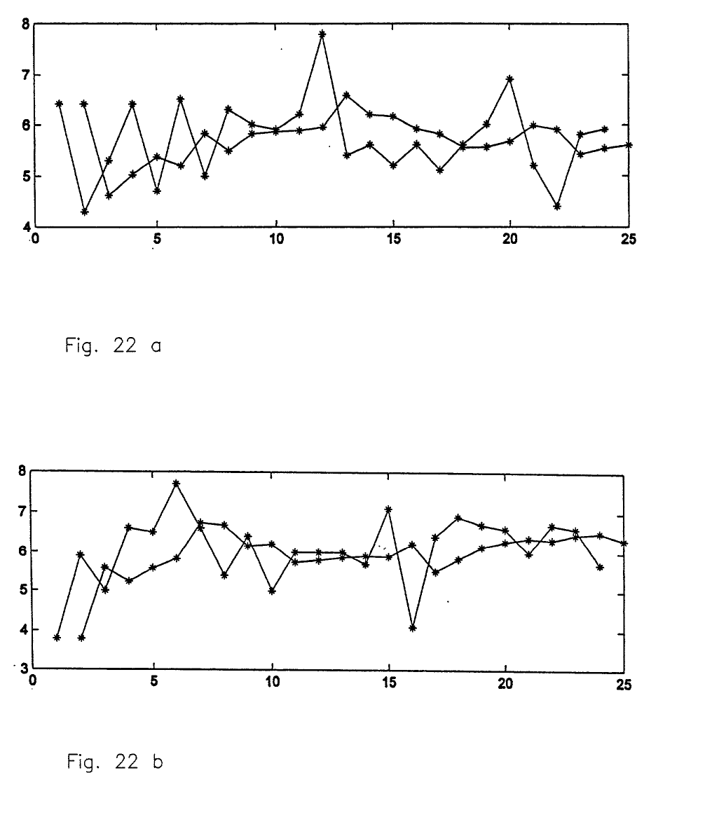

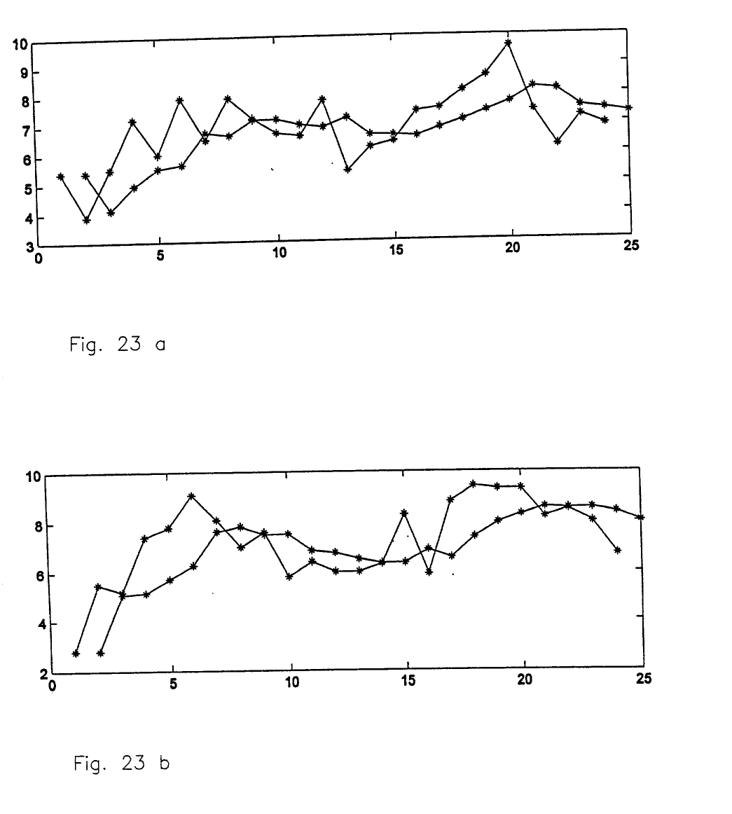

In FIG. 22a. order marks-rank marks with now exponential annual decay, constant trend and equally distributed variation is shown while in FIG. 22b. with a normally distributed variation is shown. And again order marks-rank marks with said exponential annual decay but now linear-cyclic trend and equally distributed variation is shown in FIG. 23a. and with normally distributed variation is shown in FIG. 23b.

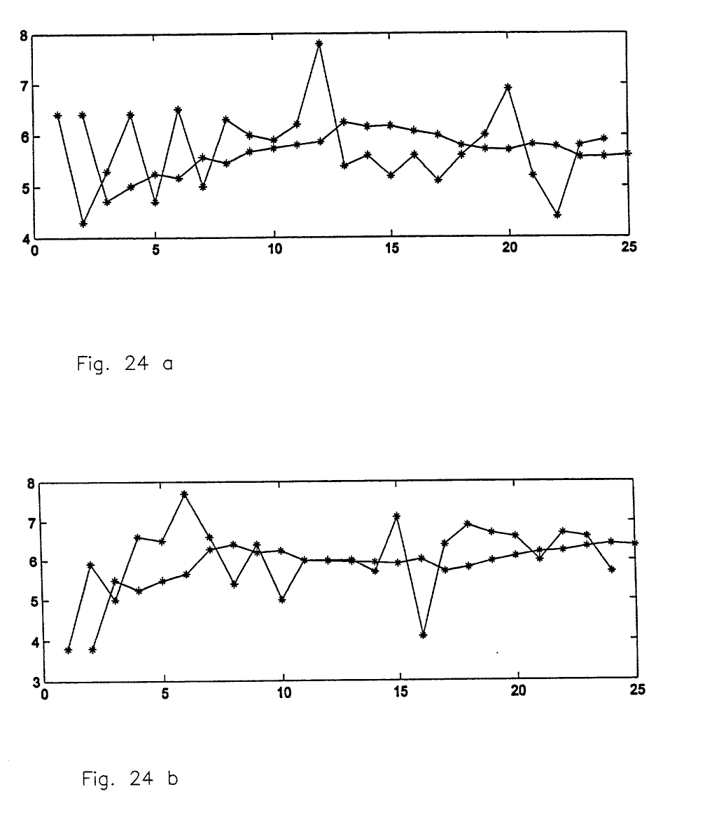

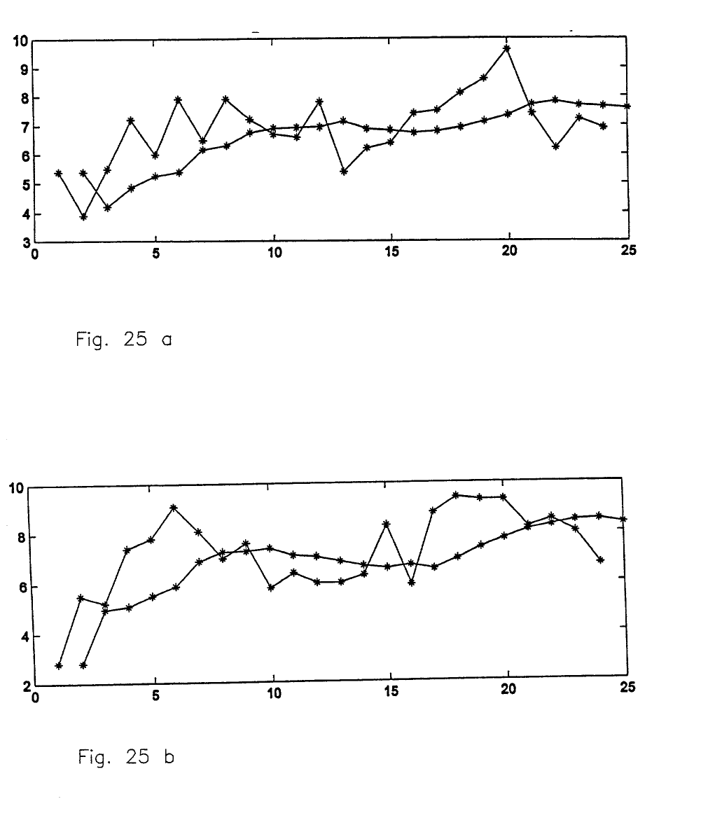

In FIG. 24a. order marks-rank marks or scores with trigonometric annual decay, constant trend and equally distributed variation while in FIG. 24b. with normally distributed variation is shown. The same trigonometric annual decay, but with linear-cyclic trend and equally distributed variation is shown in FIG. 25a. and with normally distributed variation is shown in FIG. 25b..

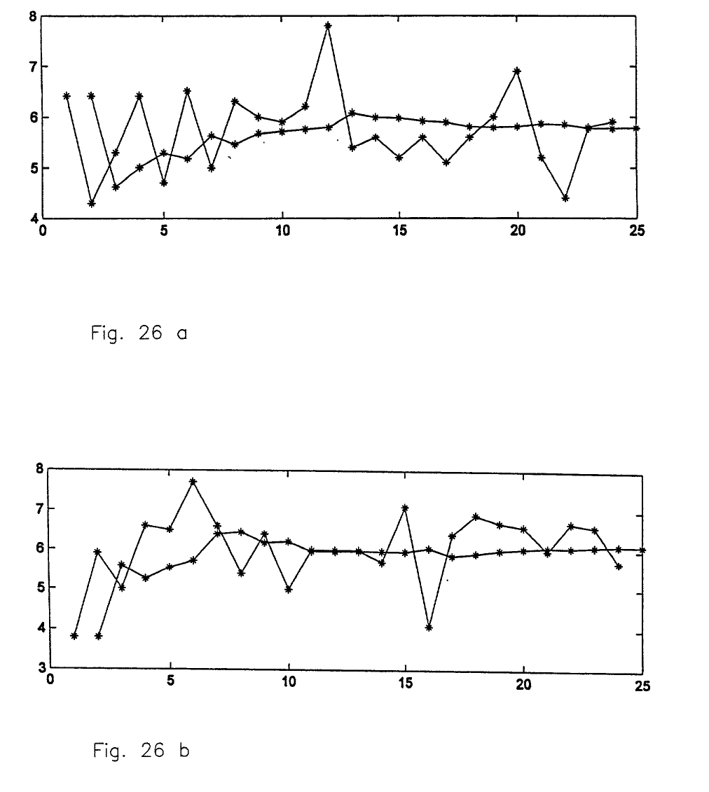

Order marks-rank marks now with root-extension decay and constant trend is shown in FIG. 26 with an equally distributed variation shown in FIG. 26a. and normally distributed variation shown in FIG. 26b.

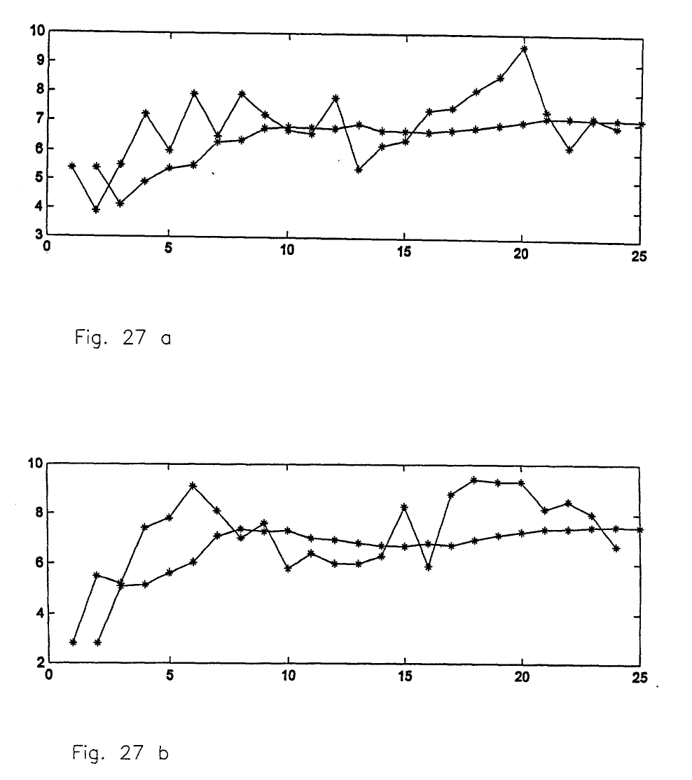

Order marks-rank marks with the same root-extension decay, but linear-cyclic trend and equally distributed variation is shown in FIG. 27a. and with linear-cyclic trend, not normally distributed variation is shown in FIG. 27b..

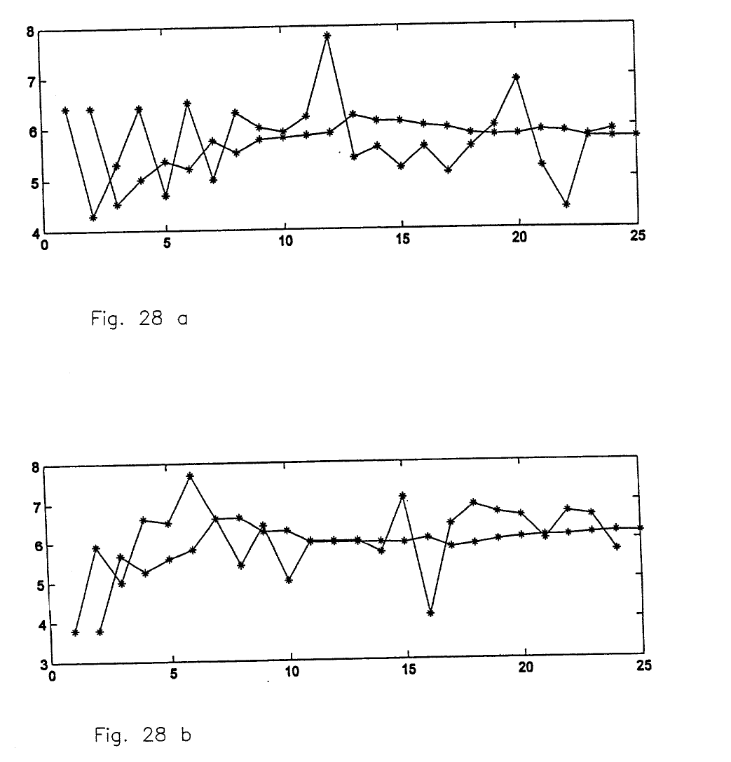

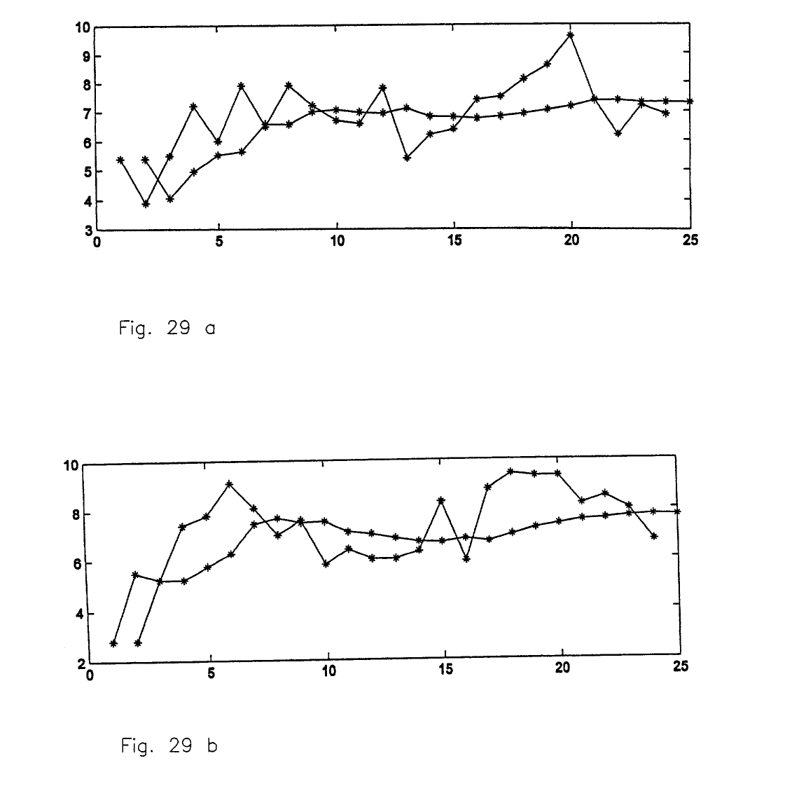

To complete the different discussed decay assumptions, in FIG. 28 are shown order marks-rank marks with now an arc-tangent extension decay. Various weightings with constant trends are shown in FIGS. 28a. (equally distributed variation) and 28b. (normally distributed variation). Same order marks-rank marks with arc-tangent extension decay and now linear-cyclic trend and equally distributed variation are shown in FIG. 29a. and linear-cyclic trend with normally distributed variation in FIG. 29b.

K. Conclusion and Variations

As can be seen from the above, the marketplace system and method discussed above attempts to obtain objective evaluation information and to make it available to buyers and sellers using the system to guide their information product transactions. The data base of information that becomes the source for the seller profile files and the buyer profile files can thus influence indirectly or directly by agreed calculation the pricing anticipated by a buyer and seller and the actual pricing used. While it is anticipated that a buyer's proposal will usually initiate the negotiations for an information product transaction, a seller's general offering of a proposal may also be the start of a negotiation. Further, while it is anticipated that the accumulated, weighted evaluation data from a plurality of order marks as statistically developed into rank marks will be most useful to seller and buyers, more anecdotal evaluation data may also be accumulated by the system. Thus, the system operator may encourage the sellers and buyers to prepare a verbal summary of the course of their work on an information product. The system operator may as an option provide access to one or more verbal summaries in a profile file (possibly for an extra fee) to supplement the statistical information.

Weighting of certain evaluation data can perform the function of emphasizing data that is more significant by reason of its recency or by reason of the transaction with which it is associated. A variety of different statistical schemes are available to provide weighting of different kinds, including a number of schemes by which the value of data decays as it ages.

What is claimed is:

1. A method for operating a marketplace for sale of information products between information sellers and information buyers, comprising:
connecting information sellers and buyers to communicate offers and communicate acceptance of offers for sale or purchase of information products;
for a sales or purchase transaction entered into, facilitating at least one transaction payment between the information seller and buyer in such transaction; and
for a transaction at least partly performed, collecting evaluation data from the information seller and information buyer on qualities of interest to future participants in the marketplace who may enter into information product transactions with such information seller and information buyer.

2. The method of claim 1 where the information buyer and information seller in a sales transaction are anonymous to each other and known to a marketplace operator.

3. The method of claim 1 further comprising processing the evaluation data under a weighting scheme and making the weighted evaluation data available to participating sellers and buyers.

4. The method of claim 1 wherein numerical scores are used in the evaluation data of the information seller and information buyer and wherein statistical methods are used for processing of evaluation data.

5. The method of claim 1 wherein the step of facilitating a transaction payment comprises providing clearing house services for financials of the marketplace.

6. The method of claim 1 wherein the step of connecting information sellers and information buyers to communicate offers and communicate acceptance comprises facilitating negotiation for a price for an information product.

7. The method of claim 3 wherein the act of making weighted evaluation data available comprises presenting data in graphs.

8. The method of claim 1 wherein the act of collecting evaluation data from the information seller and information buyer on qualities of interest comprises collecting scores on evaluation scales from the group consisting of: price setting, timeliness of delivery and fairness of service.

9. The method of claim 1 wherein the evaluation data results in a rank system with scores that aid pricing judgments of participating buyers and sellers.

10. The method of claim 1 wherein the act of collecting evaluation data comprises collecting scores on evaluation scales to evaluate a seller from the group consisting of: duration of handling, importance of the subject matter to buyer, results, usefulness, gain of information and fulfilment of personal expectations.

11. The method of claim 1 wherein the act of collecting evaluation data comprises collecting scores on evaluation scales to evaluate a buyer from the group consisting of: accuracy of problem definition and extent of supplied background information.

12. The method of claim 3 wherein the act of processing the evaluation data under a weighting scheme and making the weighted evaluation data available to participating sellers and buyers comprises processing the past history of a buyer or seller with respect to: the number and scope of previous sales transactions within the network, their distribution in time and scores provided as part of evaluation data.

13. The method of claim 1 further comprising the steps of enrolling of information product marketplace sellers and buyers, administrating the connecting between sellers and buyers, and calculating an administrative fee based on the fees of a seller in an information product transaction.

14. The method of claim 1 further comprising compiling in a data base: sales transaction identification data, data defining the times for executing development and delivery of an information product, evaluation data comprising rank marks and order marks of buyers and sellers and the rules for at least one weighting scheme for evaluation data.

15. The method of claim 1 wherein the price of an information product is determined at least in part by evaluation data for past transactions, and favourable evaluation data for a buyer tends to reduce the price paid to the seller.

16. The method of claim 1 wherein the price of an information product is determined at least in part by evaluation data for past transactions, and favourable evaluation data for a seller tends to increase the price paid to the seller.

17. The method of claim 1 wherein the price of an information product is determined at least in part by evaluation data for past transactions, and favourable evaluation data for both a seller and a buyer tends to reduce the remuneration to a marketplace operator.

18. The method of claim 1 wherein the evaluation data include numerical scores and a statistical method is used to develop marks, said method comprising development with constant or linear-cyclic trend and equally or normally distributed variation.

19. The method of claim 1 wherein the evaluation data include numerical scores and a statistical development method is used to develop at least one of order marks or rank marks, said development method comprising no decay and unitary weightings with constant or linear-cyclic trend and equally or normally distributed variation.

20. The method of claim 1 wherein the evaluation data include numerical scores and a statistical development method is used to develop at least one of order marks or rank marks, said development method comprising a linear annual decay and a constant or linear-cyclic trend with equally or normally distributed variation.

21. The method of claim 1 wherein the evaluation data include numerical scores and a statistical development method is used to develop at least one of order marks or rank marks, said development method comprising an exponential annual decay with constant or linear-cyclic trend and equally or normally distributed variation.

22. The method of claim 1 wherein the evaluation data include numerical scores and a statistical development method is used to develop at least one of order marks or rank marks, said development method comprising a trigonometric annual decay with constant or linear-cyclic trend and equally or normally distributed variation.

23. The method of claim 1 wherein the evaluation data include numerical scores and a statistical development method is used to develop at least one of order marks or rank marks, said development method comprising a root-extension decay with constant or linear-cyclic trend and equally or normally distributed variation.

24. The method of claim 1 wherein the evaluation data include numerical scores and a statistical development method is used to develop at least one of order marks or rank marks, said development method comprising an arc-tangent extension decay with constant or linear-cyclic trend and equally or normally distributed variation.

25. The method of claim 1 wherein a statistical method is selected for computing rank marks for an evaluated buyer or seller that keeps the computing expenditure for development of such marks approximately constant despite increasing numbers of transactions and resulting order marks for the buyer or seller.

26. A computer program product comprising:
a computer usable medium and computer readable program code embodied on said computer readable medium for operating a marketplace for trading in information products between information sellers and information buyers, the computer readable code comprising: computer readable program code configured to connect information sellers and information buyers to communicate offers and communicate acceptance of offers for trading in information products;
computer readable program code configured, for a trading transaction entered into, to facilitate at least one transaction payment between the information seller and information buyer in such transaction;
computer readable program code configured, for a trading transaction at least partly performed, to collect evaluation data from the information seller and information buyer on qualities of interest to future participants in the marketplace who may enter into information product transactions with such information seller and information buyer; and
computer readable program code configured to process the evaluation data under a weighting scheme and to make the weighted evaluation data available to participating sellers and buyers.

27. A computer system for operating a marketplace for trading in information products between information sellers and information buyers, comprising:
a component that connects information sellers and information buyers to communicate offers and communicate acceptance of offers for trading in information products;
a component that, for a trading transaction entered into, facilitates at least one transaction payment between the information seller and information buyer in such transaction;
a component that, for a trading transaction at least partly performed, collects evaluation data from the information seller and information buyer on qualities of interest to future participants in the marketplace who may enter into transactions with such information seller and information buyer; and
a component that processes the evaluation data under a weighting scheme and makes the weighted evaluation data available to participating sellers and buyers.

28. The system of claim 27 wherein the information buyer and seller in a sales transaction are anonymous to each other and known to a marketplace operator.

29. The system of claim 27 wherein numerical scores are used in the evaluation data of the information seller and information buyer.

30. The system of claim 27 wherein statistical methods are used in the component that processes evaluation data.

31. A method of facilitating transactions between buyers and sellers of information products comprising:
receiving from a potential buyer a proposal for an information product purchase;
communicating to at least one potential seller the potential buyer's proposal for an information product purchase, together with an associated buyer profile file;
receiving from at least one potential seller a proposal for an information product sale corresponding to the potential buyer's proposal for an information product purchase;
communicating to the potential buyer the at least one corresponding sale proposal together with an associated seller profile file;
facilitating formation of a contract between the potential buyer and at least one potential seller and payment in accordance with that contract; and
for a purchase facilitated by the method, collecting from the buyer information on its experience with the seller involved in the purchase and using such information to update the seller profile file and collecting from said seller information on its experience with the buyer involved in the purchase and using such information to update the buyer profile file.

32. The method of claim 31 wherein the information product involves development work and the contract formed involves milestones to measure progress of completion of development work.

33. The method of claim 31 wherein the step of communicating a buyer profile file comprises communicating information about the buyer's problem definition ability as experienced by prior sellers dealing with this buyer.

34. The method of claim 31 wherein the step of communicating a seller profile file comprises communicating information about the quality of a seller's information products as experienced by prior buyers dealing with this seller.

35. The method claim 31 wherein at least one of the seller information profile and the buyer information profile do not include name or other specific identification of the potential seller seller or buyer.

36. The method of claim 31 wherein the step of facilitating formation of a contract comprises presenting to the buyer and seller a menu of form contracts for purchase of an information product.

37. The method of claim 36 wherein the menu of form contracts includes contracts with different risk allocation provisions, allocating a greater or lesser degree of risk to buyer or seller.

38. The method of claim 31 further comprising the step of providing contract administration services to the parties for monitoring the performance of the agreement against agreed milestones.

39. The method of claim 38 wherein the step of providing contract administration service comprises providing milestone reminders to at least one of buyer and seller in accordance with agreed milestones.

40. The method of claim 38 wherein the step of providing contract administration services comprises providing milestone audits of seller performance against milestone criteria.

41. The method of claim 31 wherein the step of collecting from the buyer information on its experience with the seller involved in the purchase comprises collecting information responsive to criteria from the group comprising duration of handling, timeliness of delivery and usefulness of information product delivered.

42. The method of claim 41 wherein the step of collecting from the buyer information on its experience with the seller involved in the purchase comprising collecting information based on predefined rating scales.

43. The method of claim 31 wherein the step of collecting from said seller information on its experience with the buyer involved in the purchase comprises collecting information responsive to criteria from the group comprising skill in problem definition and extent of the supplied background information.

44. The method of claim 43 wherein the step of collecting from the seller information on its experience with the buyer involved in the purchase comprises collecting scores based on predefined rating scales.

45. A method of facilitating transactions between buyers and sellers of information products comprising:
receiving from a potential seller a proposal for an information product sale;
communicating to a potential buyer the potential seller's proposal for an information product sale, together with an associated seller profile file;
receiving from a potential buyer a proposal for an information product purchase corresponding to the potential seller's proposal for an information product sale;
communicating to the potential seller the corresponding purchase proposal together with an associated buyer profile file;
facilitating formation of a contract between the potential seller and at least one potential buyer and payment in accordance with that contract; and
for a purchase facilitated by the method, collecting from the buyer information on its experience with the seller involved in the purchase and using such information to update the seller profile file and collecting from said seller information on the buyer involved in the purchase and using such information to update the buyer profile file.

46. A computer program product comprising:
a computer usable medium and computer readable program code embodied on said computer readable medium for operating a marketplace for sale of information products between information sellers and information buyers, the computer readable code comprising:
computer readable program code configured to receive from a potential buyer a proposal for an information product;
computer readable program code configured to communicate to at least one potential seller the potential buyer's proposal for an information product, together with an associated buyer profile file;
computer readable program code configured to receive from at least one potential seller a proposal for an information product sale corresponding to the potential buyer's proposal for an information product;
computer readable program code configured to communicate to the potential buyer the at least one corresponding sale proposal together with an associated seller profile file;
computer readable program code configured to facilitate formation of a contract between the potential buyer and at least one potential seller and payment in accordance with that contract; and
computer readable program code configured, for a purchase facilitated by the method, to collect from the buyer information on its experience with the seller involved in the contract and using such information to update the seller profile file and collecting from said seller information on its experience with the buyer involved in the contract and using such information to update the buyer profile file.
